(19) United States
(12) Patent Application Publication
(10) Pub. No.: US 2026/0194288 A1
(43) Pub. Date: Jul. 9, 2026

(54) REFRIGERATOR

(71) Applicant: SAMSUNG ELECTRONICS CO., LTD., Suwon-si (KR)

(72) Inventors: Minseob YOOK, Suwon-si (KR); Seunghyeok SON, Suwon-si (KR); Byoungjae CHO, Suwon-si (KR); Hosang PARK, Suwon-si (KR)

(73) Assignee: SAMSUNG ELECTRONICS CO., LTD., Suwon-si (KR)

(21) Appl. No.: 19/455,541

(22) Filed: Jan. 21, 2026

Related U.S. Application Data
(63) Continuation of application No. PCT/KR2026/000068, filed on Jan. 2, 2026.

(30) Foreign Application Priority Data
Jan. 3, 2025 (KR) 10-2025-0001186
Mar. 18, 2025 (KR) 10-2025-0034882

(51) Int. Cl. F25D 23/02; F25D 29/00; G10L 15/08

(52) U.S. Cl. CPC F25D 23/028; F25D 29/00; G10L 15/08

(57) ABSTRACT

A refrigerator includes a storage compartment providing a storage space, a door to open or to close the storage compartment, a first cap door to be disposed in an upper portion of the door, a first accommodator to be disposed in the first cap door, a printed board assembly (PBA), to be disposed in the first accommodator, having a flat shape extending along one plane, and a voice receiver to be disposed on one surface of the PBA.

### CROSS-REFERENCE TO RELATED APPLICATION

This application is a continuation application, under 35 U.S.C. §111(a), of international application No. PCT/KR2026/000068, filed January 2, 2026, which claims priority under 35 U. S. C. §119 to Korean Patent Application No. 10-2025-0001186, filed January 3, 2025, and Korean Patent Application No. 10-2025-0034882, filed on March 18, 2025, the disclosures of which are incorporated herein by reference in their entireties.

### TECHNICAL FIELD

The disclosure relates to an electronic device including a voice receiver and a sound outputter.

### BACKGROUND ART

Refrigerators include a storage compartment for storing food, etc., and a cooling device that supplies cold air to the storage compartment. These cooling devices can be classified into freezing cycle devices using a freezing cycle and cooling devices using a cooling element, according to methods of generating cold air.

Freezing cycle devices obtain cold air by circulating a refrigerant along a closed circuit consisting of a compressor, a condenser, an expansion mechanism, and an evaporator. Cooling devices using a cooling element obtain cold air by using a cooling element. As a cooling element, for example, a Peltier element can be used. The Peltier effect, caused by a Peltier element, refers to a phenomenon in which, when a potential difference is applied to both sides of an object, heat flows together with a current, and thus one side is heated and the other side is cooled.

To control an operation of a refrigerator, the refrigerator may include a voice receiver for receiving a user's voice and a voice recognizer for identifying received voice information. The refrigerator may also include a sound outputter for outputting sound information indicating an operating status of the refrigerator to the user. The voice receiver for receiving a user's voice and the sound outputter for outputting sound information to the user may be disposed on the outside of a main body of the refrigerator.

### Disclosure

### Technical Solution

A refrigerator according to an embodiment of the disclosure may include a storage compartment for providing a storage space, and a door for opening or closing the storage compartment.

The refrigerator according to an embodiment of the disclosure may also include a first cap door disposed in an upper portion of the door, and a first accommodator disposed in the first cap door.

The refrigerator according to an embodiment of the disclosure may also include a printed board assembly (PBA) disposed in the first accommodator and having a flat shape extending along one plane.

The refrigerator according to an embodiment of the disclosure may also include a voice receiver disposed on one surface of the PBA.

### DESCRIPTION OF DRAWINGS

FIG. 1A is a front view of a refrigerator according to an embodiment of the disclosure.

FIG. 1B is a front view of a refrigerator of which a door is open, according to an embodiment of the disclosure.

FIG. 1C is a schematic view of a refrigerator according to an embodiment of the disclosure.

FIG. 2 is a block diagram of a refrigerator according to an embodiment of the disclosure.

FIG. 3 is a perspective view of a door according to an embodiment of the disclosure.

FIG. 4 is an exploded perspective view of the door, a voice recognition module, and a sound output module illustrated in FIG. 3.

FIG. 5 is a magnified perspective view of a region M of FIG. 3.

FIG. 6 is a partial front view of a door according to an embodiment of the disclosure.

FIG. 7 is an exploded perspective view in which an upper case of a voice entry module in FIG. 5 is separated from a first cap door.

FIG. 8A is a front perspective view of a printed board assembly (PBA) according to an embodiment of the disclosure.

FIG. 8B is a side view of the PBA according to an embodiment of the disclosure.

FIG. 9 is a perspective view of a voice entry module according to an embodiment of the disclosure.

FIG. 10A is a perspective view of a first cap door according to an embodiment of the disclosure.

FIG. 10B is a partial perspective view of the first cap door according to an embodiment of the disclosure.

FIG. 11 is an exploded perspective view in which a voice entry module according to an embodiment of the disclosure is separated from a first cap door.

FIG. 12 is a partial cross-sectional view of the door taken along line A-A' shown in FIG. 5.

FIG. 13 is a partial perspective view of a door according to an embodiment of the disclosure.

FIG. 14 is an exploded perspective view of a PBA according to an embodiment of the disclosure.

FIG. 15 is a partial cross-sectional view of the door taken along line B-B' shown in FIG. 13.

FIG. 16 is a perspective view of a door according to an embodiment of the disclosure.

FIG. 17A is a perspective view of a sound output module according to an embodiment of the disclosure.

FIG. 17B is a perspective view of a sound output module according to an embodiment of the disclosure.

FIG. 18 is a partial cross-sectional view of the door taken along line C-C shown in FIG. 16.

### Mode for Invention

It should be understood that various embodiments of the disclosure in this document and terms used therein are not intended to limit the technical features described herein to particular embodiments of the disclosure and that the disclosure includes various modifications, equivalents, or substitutions of the embodiments of the disclosure.

With regard to the description of the drawings, like reference numerals may be used to represent like or related elements.

The singular form of a noun corresponding to an item may include one item or a plurality of items, unless a relevant context clearly dictates otherwise.

As used herein, each of the phrases such as "A or B," "at least one of A and B," "at least one of A or B," "A, B, or C," "at least one of A, B, and C," and "at least one of A, B, or C" may include any one of the items listed together in a corresponding one of the phrases, or all possible combinations thereof.

Terms such as "first," "second," etc. may be used simply to distinguish an element from other elements and do not limit the elements in any other respect (e.g., importance or order).

It will be understood that when an element (e.g., a first element) is referred to, with or without the term "functionally" or "communicatively," as being "coupled" or "connected" to another element (e.g., a second element), the element may be coupled to the other element directly (e.g., in a wired manner), wirelessly, or via a third element.

The terms such as "comprise," "include," or "have" are intended to specify the presence of stated features, numbers, steps, operations, elements, components, or combinations thereof, but do not preclude the presence or addition of one or more other features, numbers, steps, operations, elements, components, or combinations thereof.

It will also be understood that when an element is referred to as being "connected," "coupled," "supported," or "in contact" with another element, this includes not only when the elements are directly connected, coupled, supported, or in contact, but also when they are indirectly connected, coupled, supported, or in contact via a third element.

It will also be understood that when an element is referred to as being "on" another element, the element may be directly on the other element, or intervening elements may also be present therebetween.

The term "and/or" used herein includes any and all combinations of one or more of the associated listed items.

The operational principle of the disclosure and embodiments thereof will now be described more fully with reference to the accompanying drawings.

A refrigerator according to an embodiment of the disclosure may include a main body.

The "main body" may include an inner case, an outer case disposed on the outside of the inner case, and an insulating material provided between the inner case and the outer case.

The "inner case" may include at least one of a case, a plate, a panel, or a liner that forms a storage compartment. The inner case may be formed as a single body or may be formed by assembling a plurality of plates. The "outer case" may form the outer appearance of the main body, and may be coupled to the outside of the inner case such that the insulating material is disposed between the inner case and the outer case.

The "insulating member" may insulate the inside and outside of the storage compartment so that an internal temperature of the storage compartment may be maintained at a set appropriate temperature without being affected by an environment outside the storage compartment. According to an embodiment of the disclosure, the insulating member may include a foam insulating material. The foam insulating material may be formed by injecting and foaming urethane foam, which is a mixture of polyurethane and a foaming agent, between the inner case and the outer case.

According to an embodiment of the disclosure, the insulating member may further include a vacuum insulating material in addition to the foam insulating material, or the insulating member may consist solely of a vacuum insulating material instead of the foam insulating material. The vacuum insulating material may include a core portion, and an outer shell portion that accommodates the core portion and seals the interior under a vacuum or a pressure approximate to the vacuum. However, the insulating member is not limited to the foam insulating material or vacuum insulating material described above, and may include various materials usable for insulation.

The "storage compartment" may include a space defined by the inner case. The storage compartment may further include an inner case that defines the space corresponding to the storage compartment. The storage compartment may store various items such as food, medicine, and cosmetics, and the storage compartment may be formed such that at least one side thereof may be opened for taking items in and out.

The refrigerator may include one or more storage compartments. When two or more storage compartments are formed in the refrigerator, the two or more storage compartments may have different purposes and may be maintained at different temperatures. To this end, the two or more storage compartments may be partitioned from each other by a barrier wall including an insulating material.

The storage compartment may be provided to maintain an appropriate temperature range according to its purposes, and may include a "refrigerating compartment," a "freezing compartment," or a "temperature-changing compartment" which are distinguished from each other according to their purposes and/or temperature ranges. The refrigerating compartment may be maintained at an appropriate temperature for refrigerating items, and the freezing compartment may be maintained at an appropriate temperature for freezing items. "Refrigerating" may refer to keeping items cold without freezing. For example, a refrigerating compartment may be kept at a temperature ranging from 0 degrees Celsius to 7 degrees Celsius. "Freezing" may refer to cooling items so that items are frozen or remain frozen. For example, a freezing compartment may be kept at a temperature ranging from -20 degrees Celsius to -1 degree Celsius. The temperature-changing compartment may be used as either a refrigerating compartment or a freezing compartment, with or without a user's choice.

In addition to names, such as a "refrigerating compartment," a "freezing compartment," and a "temperature-changing compartment," the storage compartment may also be referred to as any of various other names such as a "vegetable compartment," a "fresh compartment," a "cooling compartment," and an "ice-making compartment." The terms "refrigerating compartment," "freezing compartment," and "temperature-changing compartment" used hereinafter should be understood to encompass storage compartments having their corresponding purposes and temperature ranges.

According to an embodiment of the disclosure, the refrigerator may include at least one door configured to open or close the open side of the storage compartment. Doors may be provided to open or close one or more storage compartments, respectively, or one door may be provided to open or close a plurality of storage compartments. The door may be installed on a front side of the body in a pivoting or sliding manner.

The "door" may be configured to seal the storage compartment when the door is closed. Similar to the main body, the door may include an insulating material to seal the storage compartment when the door is closed.

According to an embodiment of the disclosure, the door may include a door outer panel forming a front side of the door, a door inner panel forming a back side of the door and facing the storage compartment, an upper cap, a lower cap, and a door insulating material provided inside the upper and lower caps.

An edge of the door inner panel may be provided with a sealing unit that seals the storage compartment by coming into contact with the front side of the main body when the door is closed. The door inner panel may include a dyke that protrudes rearward to accommodate a door basket for storing items.

According to an embodiment of the disclosure, the door may include a door body, and a front panel detachably coupled to a front side of the door body and forming the front side of the door. The door body may include a door outer panel forming a front side of the door body, a door inner panel forming a back side of the door body and facing the storage compartment, an upper cap, a lower cap, and a door insulating material provided inside the upper and lower caps.

According to arrangements of a door and a storage compartment, refrigerators may be classified into French door type refrigerators, side-by-side type refrigerators, bottom mounted freezers (BMFs), top mounted freezers (TMFs), or one-door refrigerators.

According to an embodiment of the disclosure, the refrigerator may include a cooling device provided to supply cold air to the storage compartment.

The "cooling device" may include a machine, a mechanism, or an electronic device capable of producing and guiding cold air to cool the storage compartment, and/or a system corresponding to a combination thereof.

According to an embodiment of the disclosure, the cooling device may produce cold air through a freezing cycle including compression, condensation, expansion, and evaporation of a refrigerant. To this end, the cooling device may include a freezing cycle device having a compressor, a condenser, an expansion device, and an evaporator capable of driving the freezing cycle. According to an embodiment of the disclosure, the cooling device may include a semiconductor such as a thermoelectric element. The thermoelectric element may cool the storage compartment by generating heat and cooling through the Peltier effect.

According to an embodiment of the disclosure, the refrigerator may include a machine compartment in which at least some components belonging to the cooling device are arranged.

The "machine compartment" may be provided to be separated and insulated from the storage compartment in order to prevent heat generated by components placed in the machine compartment from being transferred to the storage compartment. The interior of the machine compartment may be configured to communicate with the exterior of the main body in order to dissipate heat from the components placed inside the machine compartment.

According to an embodiment of the disclosure, the refrigerator may include a dispenser provided in the door to provide water and/or ice. The dispenser may be provided on the door so that a user may access water and/or ice without opening the door.

According to an embodiment of the disclosure, the refrigerator may include an ice-making device provided to produce ice. The ice-making device may include an ice-making tray that stores water, an ice-separating device that separates ice from the ice-making tray, and an ice bucket that stores ice produced in the ice-making tray.

According to an embodiment of the disclosure, the refrigerator may include a controller for controlling the refrigerator.

The "controller" may include a memory that stores or memorizes a program and/or data for controlling the refrigerator, and a processor that outputs a control signal for controlling a cooling device, etc. according to the program and/or data memorized in the memory.

The memory stores or records various pieces of information, various data, various instructions, various programs, etc. necessary for operations of the refrigerator. The memory may store temporary data generated during generation of control signals for controlling the components included in the refrigerator. The memory may include one or both of volatile memory and nonvolatile memory, or a combination thereof.

The processor controls overall operations of the refrigerator. The processor may control the components of the refrigerator by executing the programs stored in the memory. The processor may include a separate network processing unit (NPU) that performs an operation of an artificial intelligence model. The processor may also include a central processing unit (CPU), a graphics processing unit (GPU), etc. The processor may generate a control signal for controlling an operation of a cold air supply device. For example, the processor may receive temperature information of the storage compartment from a temperature sensor, and may generate a cooling control signal for controlling an operation of the cooling device, based on the temperature information of the storage compartment.

In addition, the processor may process a user input of a user interface according to the program and/or data stored/stored in the memory, and may control an operation of the user interface. The user interface may be provided using an input interface and an output interface. The processor may receive a user input from the user interface. Moreover, the processor may transmit, to the user interface, a display control signal and image data for displaying an image on the user interface in response to the user input.

The processor and the memory may be integrally provided with each other or provided separately from each other. The processor may include one or more processors. For example, the processor may include a main processor and at least one subprocessor. The memory may include one or more memories.

According to an embodiment of the disclosure, the refrigerator may include a processor and a memory that control all of the components included in the refrigerator, or may include a plurality of processors and a plurality of memories that individually control the components of the refrigerator. For example, the refrigerator may include a processor and a memory that control an operation of the cooling device according to an output of a temperature sensor. The refrigerator may also include a separate processor and a separate memory that control an operation of a user interface according to a user input.

A communication module may communicate with an external device, such as a server, a mobile device, or another home appliance, via a nearby access point (AP). The AP may connect a local area network (LAN) to which the refrigerator or a user device is connected to a wide area network (WAN) to which a server is connected. The refrigerator or the user device may be connected to the server via the WAN.

The input interface may include a key, a touch screen, a microphone, etc. The input interface may receive a user input and transmit the user input to the processor.

The output interface may include a display, a speaker, etc. The output interface may output various notifications, messages, pieces of information, etc. generated by the processor.

Refrigerators according to various embodiments of the disclosure will now be described in detail with reference to the attached drawings.

Refrigerators according to various embodiments of the disclosure will now be described in detail with reference to the attached drawings.

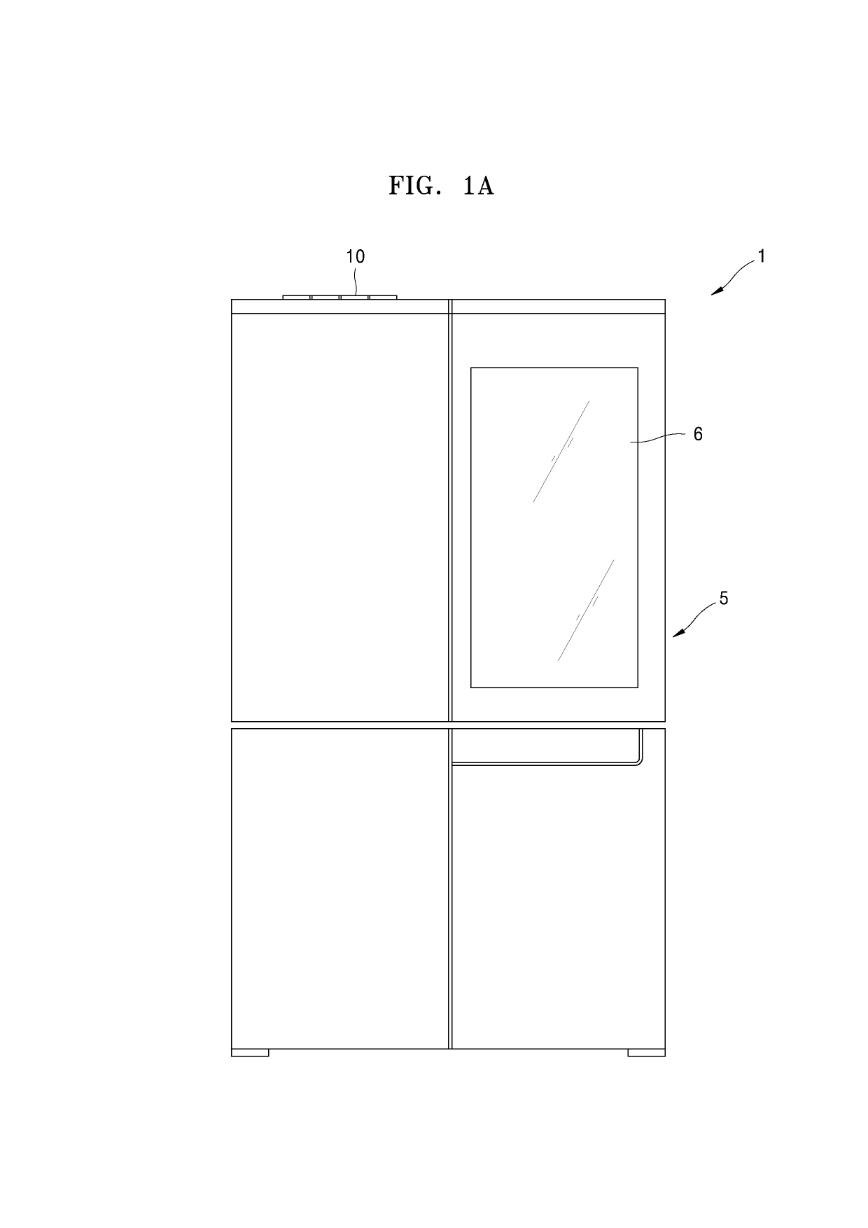

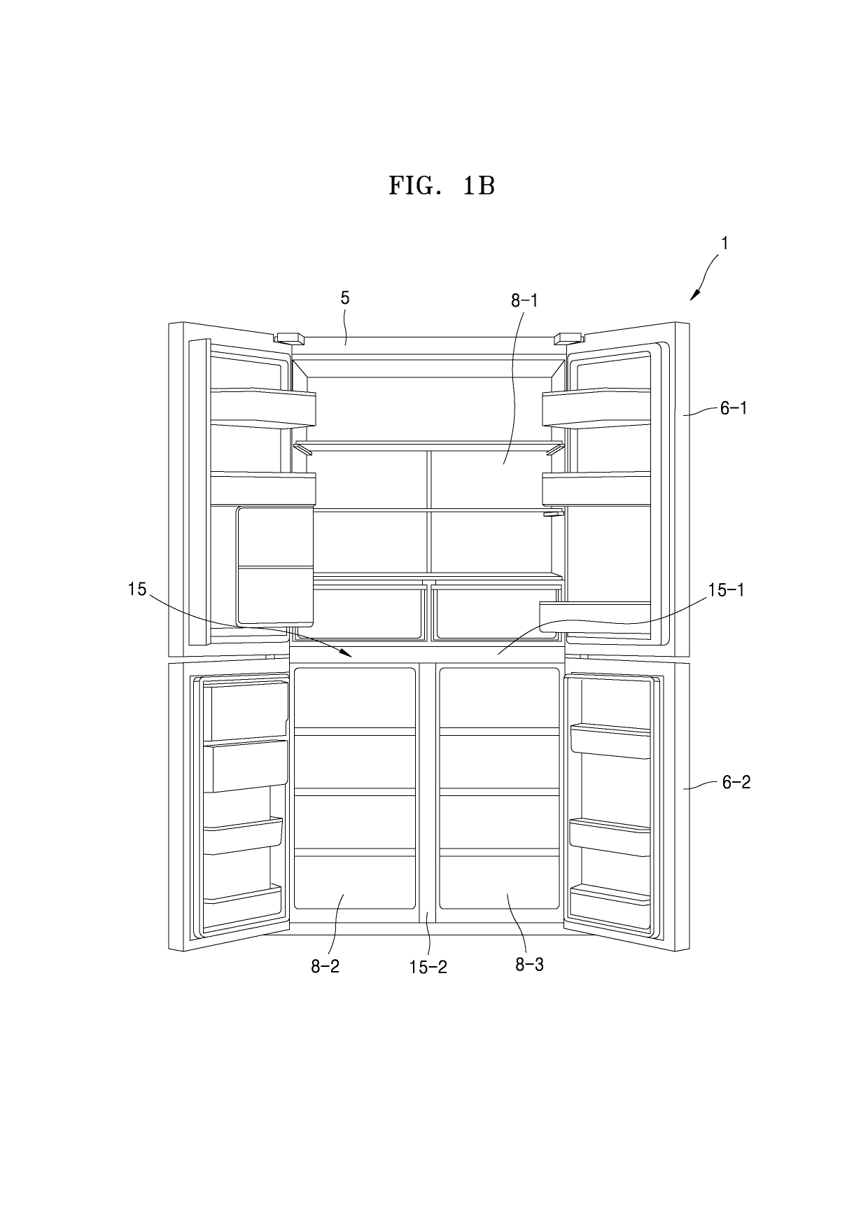

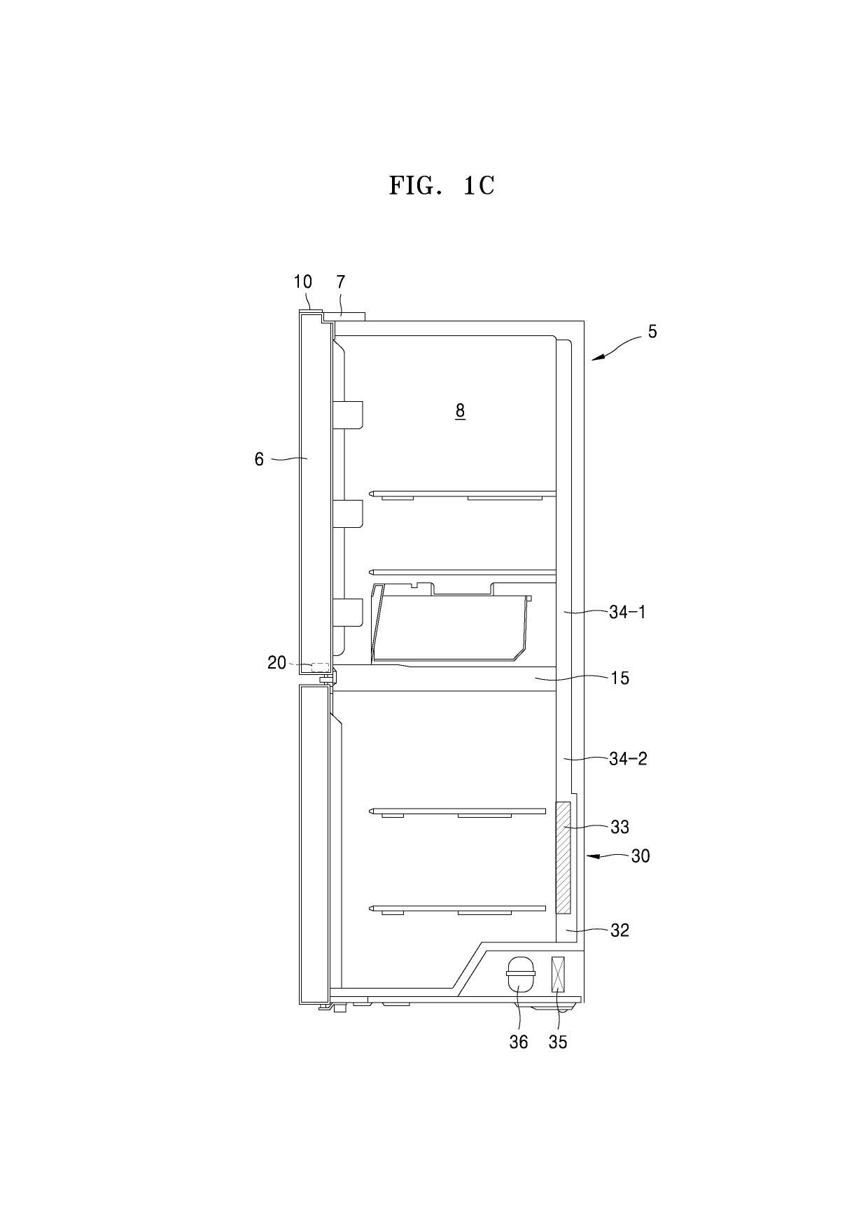

FIG. 1A is a front view of a refrigerator according to an embodiment of the disclosure. FIG. 1B is a front view of a refrigerator of which a door is open, according to an embodiment of the disclosure. FIG. 1C is a schematic view of a refrigerator according to an embodiment of the disclosure.

Referring to FIGS. 1A through 1C, a refrigerator 1 according to an embodiment of the disclosure may cool stored items stored in a storage compartment 8. To cool the stored items stored in the storage compartment 8, the refrigerator 1 may include a cooling device 30.

The cooling device 30 according to an embodiment of the disclosure may implement a freezing cycle of cools the storage compartment 8 provided in a main body portion 5 of refrigerator 1 through a thermodynamic process of generally absorbing heat at a low temperature and a low pressure and releasing heat at a high temperature and a high pressure by using a refrigerant, which is a substance that changes sensitively to temperature and pressure. For example, the cooling device 30 may include an evaporator 33 for supplying cooling air to the storage compartment 8, a condenser 35 for converting a high-temperature, high-pressure gaseous refrigerant into a high-temperature, high-pressure liquid refrigerant, an expander (not shown) for changing the high-temperature, high-pressure liquid refrigerant into a low-temperature, low-pressure liquid refrigerant, and a compressor 36 for converting a low-temperature, low-pressure gaseous refrigerant into the high-temperature, high-pressure gaseous refrigerant.

According to an embodiment of the disclosure, the main body portion 5 may form an outer appearance of the refrigerator 1. The main body portion 5 may include the storage compartment 8 formed by being partitioned vertically inside, and a plurality of doors 6 for opening or closing the storage compartment 8.

The storage compartment 8 may be divided into a plurality of sections by a partition portion 15, and a plurality of shelves and a plurality of storage containers may be arranged inside the storage compartment 8 to store food, etc. The storage compartment 8 may be split into a plurality of storage compartments by the partition portion 15. The partition portion 15 may include a first partition 15-1 that is horizontally coupled to the inside of the storage compartment 8 and splits the storage compartment 8 into an upper storage compartment 8-1 and lower storage compartments 8-2 and 8-3, and a second partition 15-2 that is vertically coupled to the lower storage compartments 8-2 and 8-3 to split the lower storage compartments 8-2 and 8-3.

The first partition 15-1 and the second partition 15-2 may be coupled to each other such that the partition portion 15 having a T shape may split the storage compartment 8 into three spaces. Among the upper storage compartment 8-1 and the lower storage compartments 8-2 and 8-3 obtained by the first compartment 15-1, the upper storage compartment 8-1 may be used as a refrigerating compartment, and the lower storage compartments 8-2 and 8-3 may be used as freezing compartments.

Such split of the storage compartment 8 is an example, and the storage compartment 8) may be used differently from the above description.

The storage compartment 8 may be opened or closed by a plurality of doors 6. The plurality of doors 6 may be arranged to be spaced apart from each other with a preset interval between them. For example, the plurality of doors 6 may be arranged on a front surface of the main body portion 5 to open or close an opening provided in the main body portion 5.

The upper storage compartment 8-1 may be opened or closed by an upper door 6-1 that is pivotably coupled to the main body portion 5 in which the storage compartment 8 is provided. The lower storage compartments 8-2 and 8-3 may be opened or closed by a lower door 6-2 that is pivotably coupled to the main body portion 5 in which the storage compartment 8 is provided.

According to an embodiment of the disclosure, the air in the storage compartment 8 may move to the evaporator 33 through a return duct 32 for the storage compartment 8 by a blower fan (not shown). The air that has moved through the return duct 32 for the storage compartment 8 may be cooled via a heat exchange with the evaporator 33. The cooled air may be repeatedly discharged to the storage compartment 8 through cool air discharge ports (not shown) of cool air ducts 34-1 and 34-2.

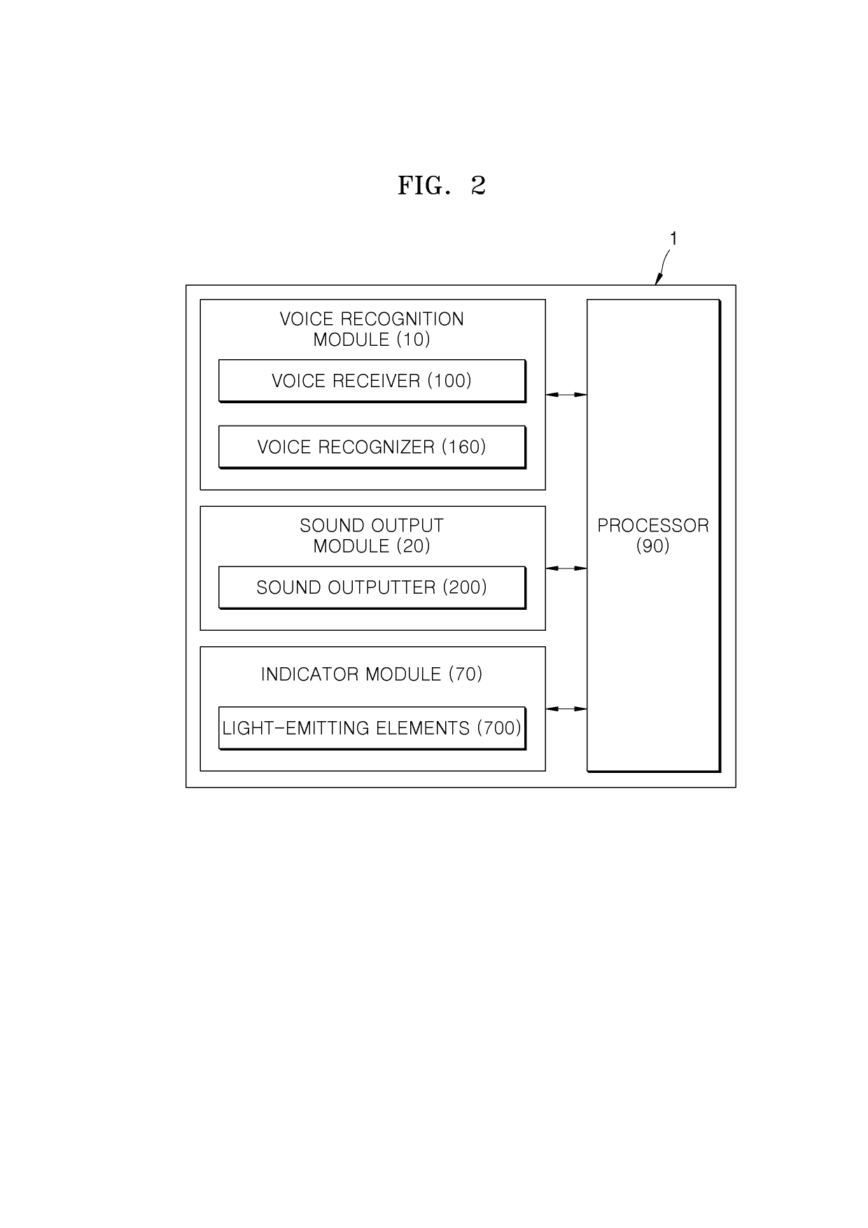

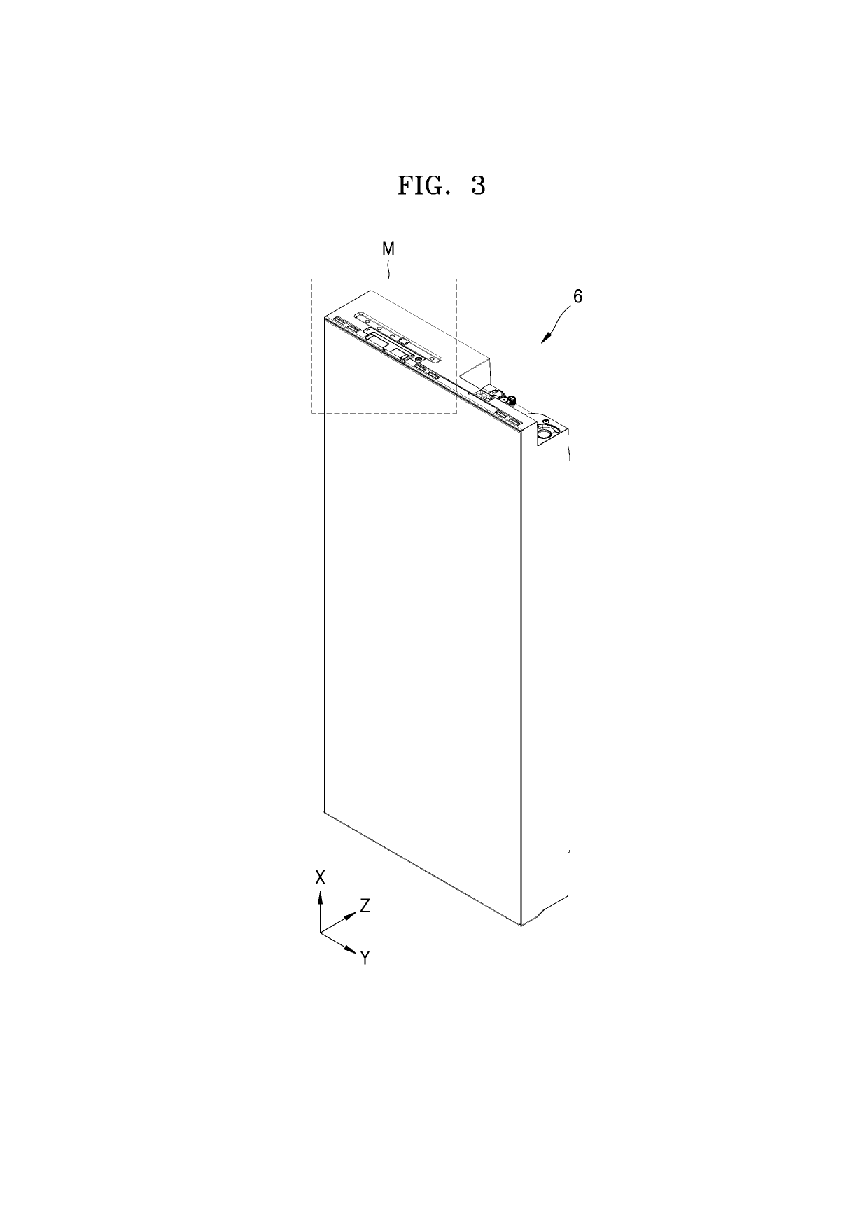

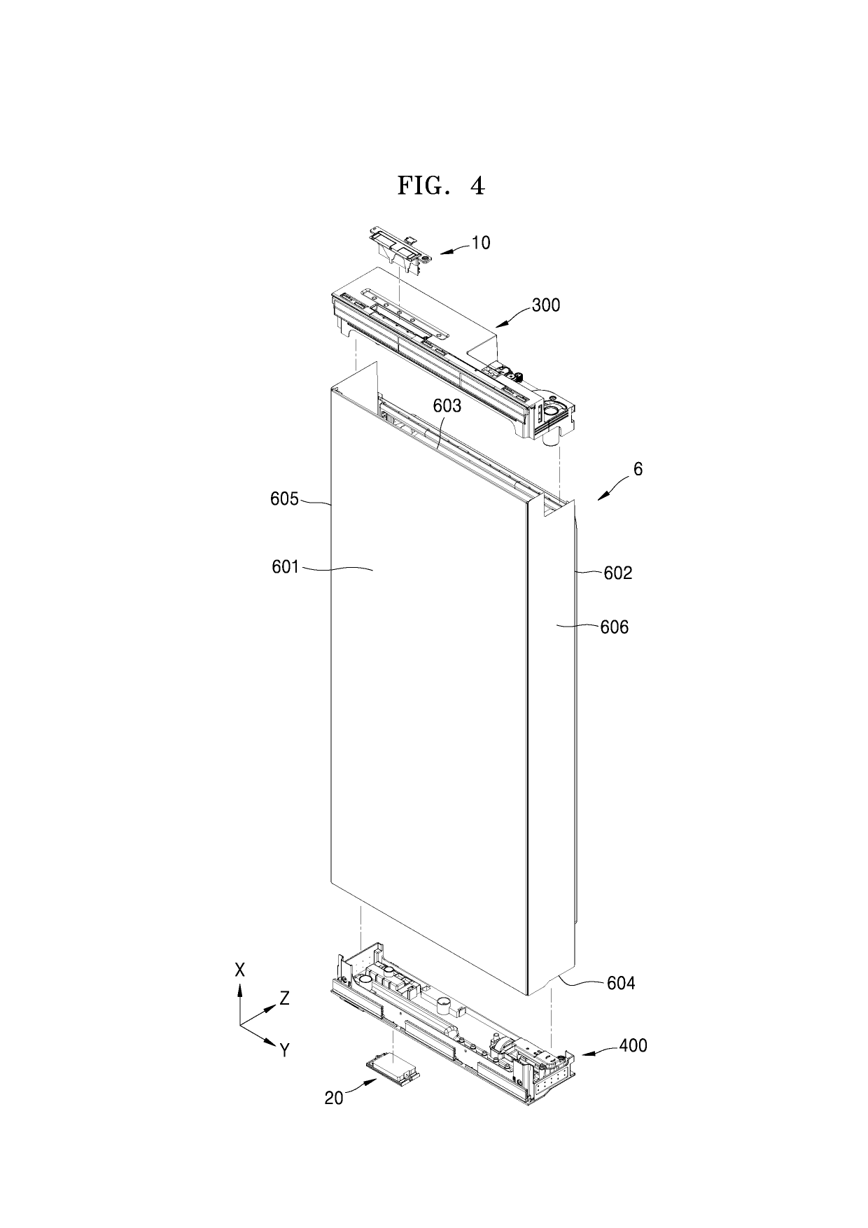

FIG. 2 is a block diagram of the refrigerator 1 according to an embodiment of the disclosure. FIG. 3 is a perspective view of the door 6 according to an embodiment of the disclosure. FIG. 4 is an exploded perspective view of the door 6, a voice recognition module 10, and a sound output module 20 illustrated in FIG. 3.

Referring to FIGS. 2 through 4, the refrigerator 1 according to an embodiment of the disclosure may include the voice recognition module 10 and the sound output module 20 for controlling an operation of the refrigerator 1 or notifying an operating status of the refrigerator 1. For example, the voice recognition module 10 may receive a voice generated by a user and recognize the meaning of the received voice. In addition, the sound output module 20 may output sound to the outside to inform the user of a control status, operating status, or the like of the refrigerator 1.

According to an embodiment of the disclosure, the voice recognition module 10 may be included in the refrigerator 1 to simply change complex settings of the refrigerator 1 through voice without manipulating an input unit, for example, a touch screen. When a refrigerator is controlled by voice without touching a touchscreen, the refrigerator may be used more hygienically.

In addition, when a user is cooking or returning from shopping and holding items in his or her both hands, the user may perform control of the refrigerator 1, such as temperature adjustment, function setting, and music playback of the refrigerator 1, via a voice command. Moreover, more accurate and personalized services may be provided through learning of the user's voice patterns and preferences.

According to an embodiment of the disclosure, the voice recognition module 10 may include a voice receiver 100 capable of receiving a user's voice. For example, the voice receiver 100 may be a microphone. The voice received through the voice receiver 100 may be transmitted to the voice recognizer 160. The voice recognizer 160 may recognize the voice received through the voice receiver 100 by using voice recognition software. For example, the voice recognition software included in the voice recognizer 160 may recognize the voice received through the voice receiver 100 by using artificial intelligence (AI) technology. A processor 90 may control the operation of the refrigerator 1 according to a voice command recognized through the voice recognizer 160.

According to an embodiment of the disclosure, the sound output module 20 may output sound to the outside. The sound output module 20 may include a sound outputter 200 to output sound to the outside. The processor 90 may check the operating status of the refrigerator 1 and transmit output information about the status of the refrigerator 1 to the user through the sound outputter 200. The sound outputter 200 may output sound according to the output information received from the processor 90.

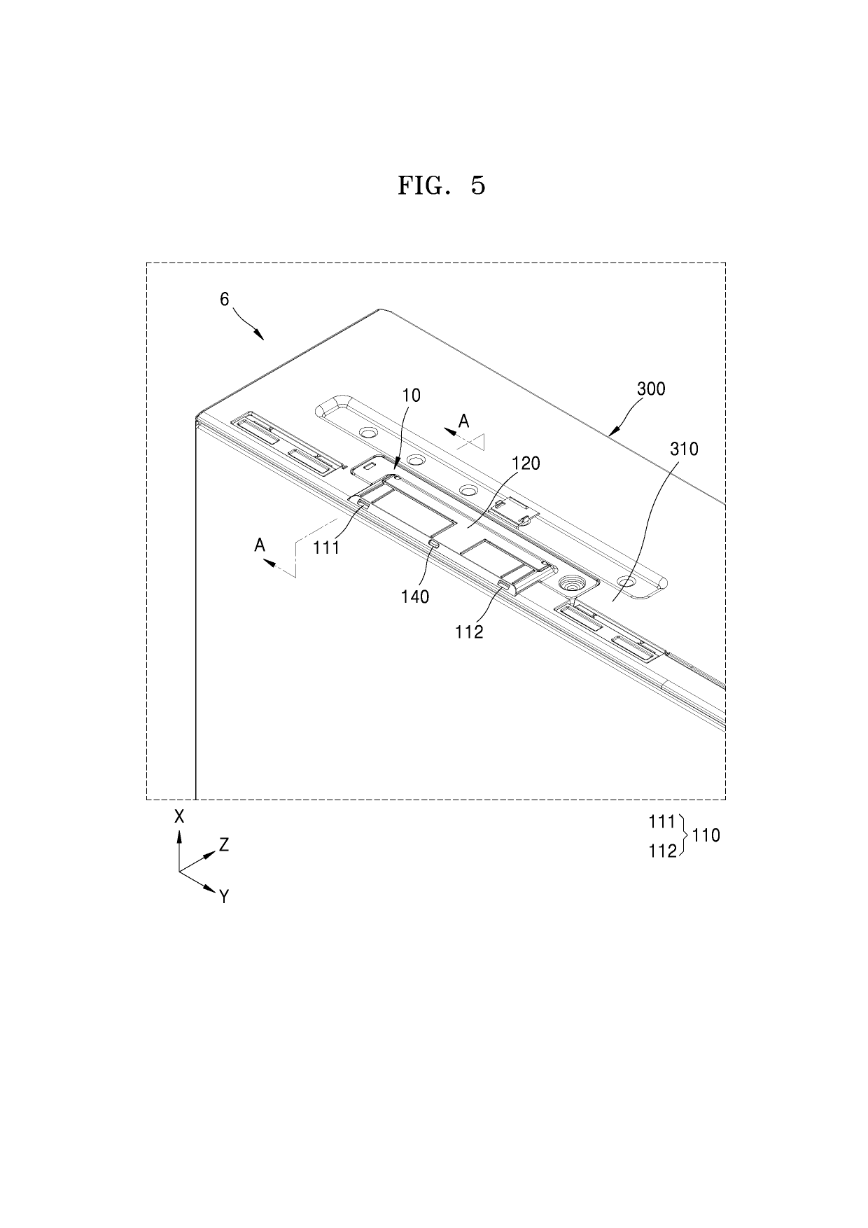

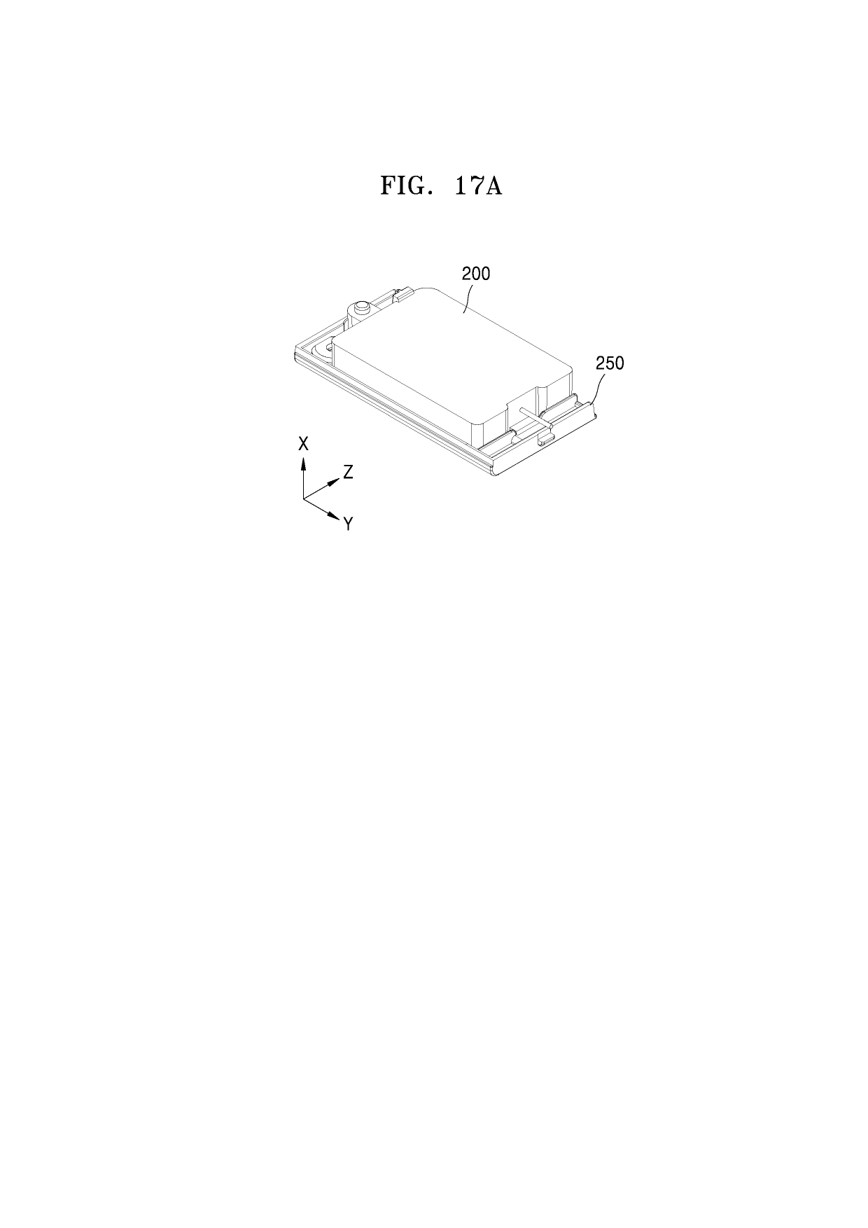

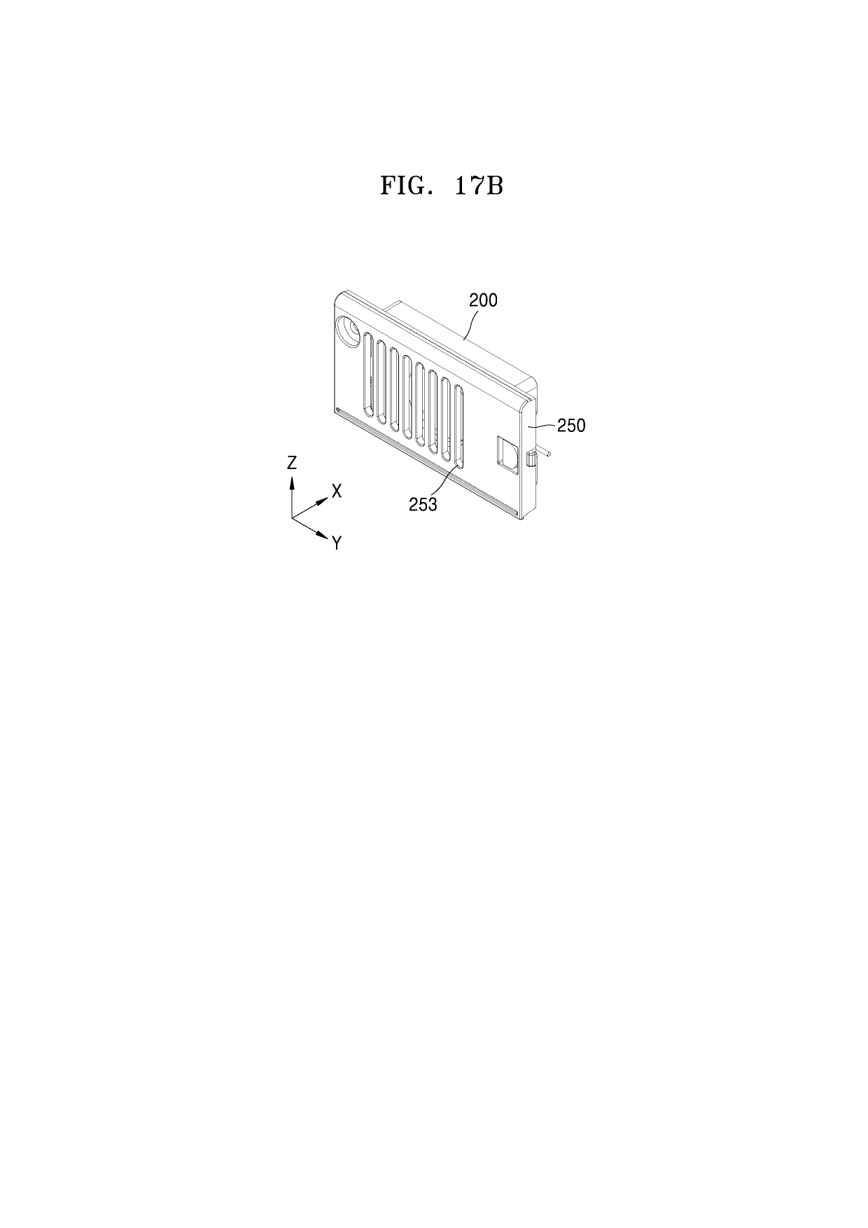

According to an embodiment of the disclosure, when a voice in the form of a sound wave having a preset frequency is received from the outside, a voice entry hole 110 (see FIG. 5) in an opening shape needs to be arranged such that the voice enters. In addition, when a sound in the form of a sound wavehaving a preset frequency is output to the outside, a sound discharge hole 253 (see FIG. 17B) in an opening shape for discharging sound to the outside needs to be arranged. When the voice entry hole 110 in an opening shape and the sound discharge hole 253 (see FIG. 17B) in an opening shape are arranged in the main body portion 5 forming the exterior of the refrigerator 1, the aesthetic appeal of the refrigerator 1 may be reduced. Therefore, the voice entry hole 110 and the sound discharge hole 253 (see FIG. 17B) need to be arranged in a location in the main body portion 5 that is not visually recognized from the outside.

The door 6 according to an embodiment of the disclosure may be provided in a flat plate shape having a preset thickness. When the door 6 has a flat plate shape having a preset thickness, the door 6 may include a front surface 601 exposed to the outside, a rear surface 602 disposed to face the storage compartment 8 when the storage compartment 8 is closed, an upper surface 603 disposed between the front surface 601 and the rear surface 602, a lower surface 604, a first lateral surface 605, and a second lateral surface 606.

In this specification, a first direction X with respect to the door 6 refers to a lengthwise direction of the door 6, for example, a direction from the upper surface 603 to the lower surface 604. In addition, a second direction Y refers to a widthwise direction of the door 6, for example, a direction from the first lateral surface 605 to the second lateral surface 606. In addition, a third direction Z refers to a thickness direction of the door 6, for example, a direction from the front surface 601 to the rear surface 602.

According to an embodiment of the disclosure, a first cap door 300 may be disposed on an upper portion of the door 6, and a second cap door 400 may be disposed on a lower portion of the door 6. For example, the voice recognition module 10 may be disposed in the first cap door 300, and the sound output module 20 may be disposed in the second cap door 400.

As shown in FIGS. 1A through 1C, the door 6 may include the upper door 6-1 for opening or closing the upper storage compartment 8-1, and the lower door 6-2 for opening or closing the lower storage compartments 8-2 and 8-3. The door 6 in which the voice recognition module 10 and the sound output module 20 are arranged may be the upper door 6-1 for opening or closing the upper storage compartment 8-1. According to an embodiment of the disclosure, the voice recognition module 10 may be disposed in the first cap door 300, which is disposed on the upper surface 603 of the upper door 6-1, in consideration of sound reception efficiency according to the user's height. In addition, the sound output module 20 may be disposed in the second cap door 400, which is disposed on the lower surface 604 of the upper door 6-1, in consideration of external visibility and reverberation of sound by the lower door 6-2.

In the above-described embodiment of the disclosure, the refrigerator 1 in which the storage compartment 8 is split into upper and lower compartments, for example, the upper storage compartment 8-1 and the lower storage compartments 8-2 and 8-3, has been described. However, the disclosure is not limited thereto. For example, in the case of side-by-side doors by which refrigerator and freezer compartments of the refrigerator 1 are separated to the left and right, the voice recognition module 10 may be disposed on an upper end of either the left or right door. Moreover, the sound output module 20 may be disposed on a lower end of either the left or right door, by taking into account external visibility and reverberation of sound by the ground.

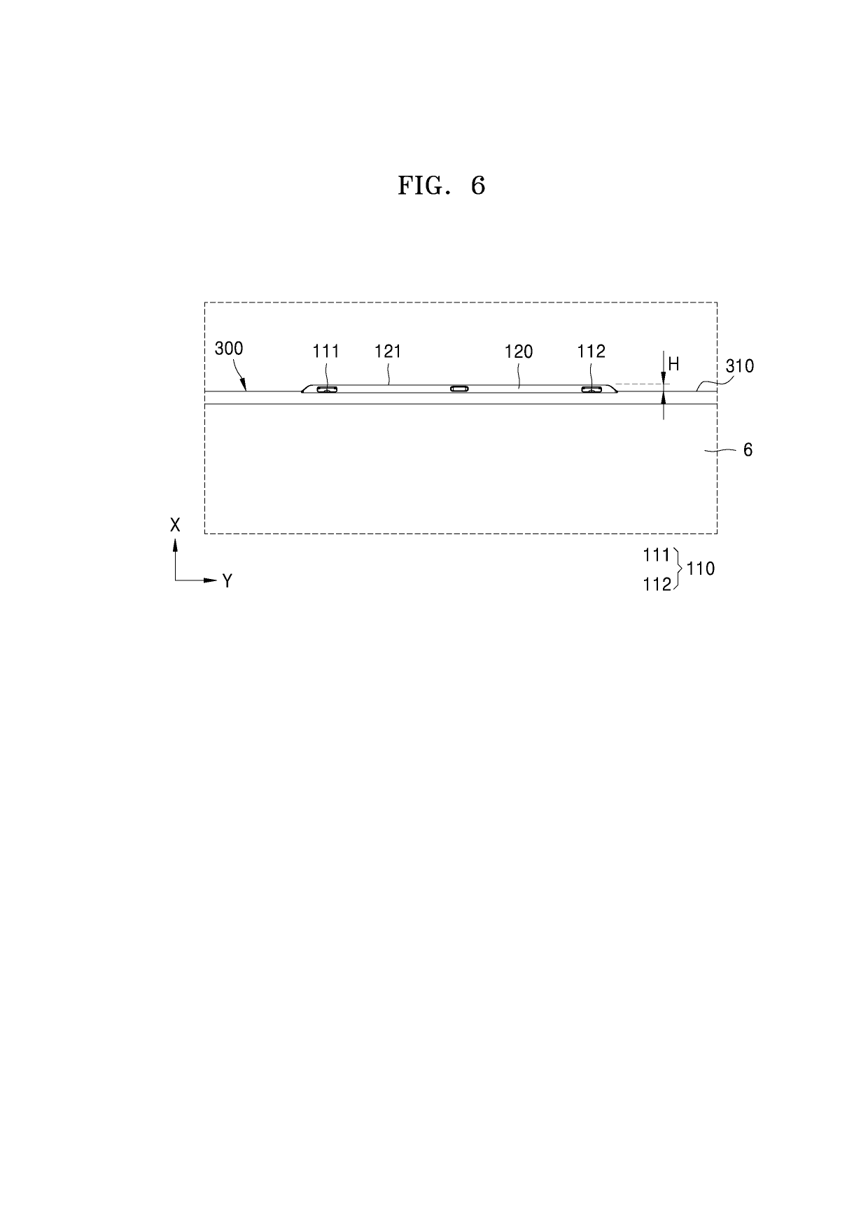

FIG. 5 is a magnified perspective view of a region M of FIG. 3. FIG. 6 is a partial front view of a door according to an embodiment of the disclosure.

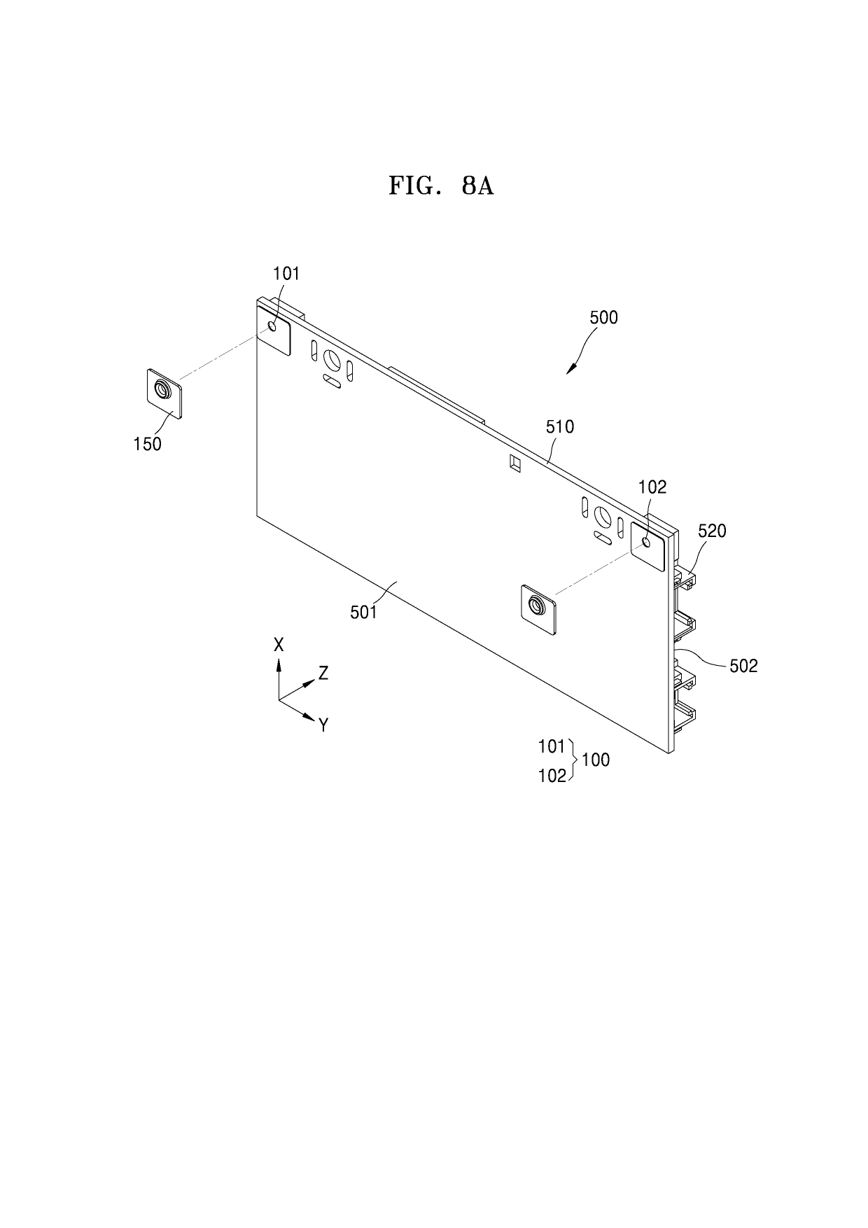

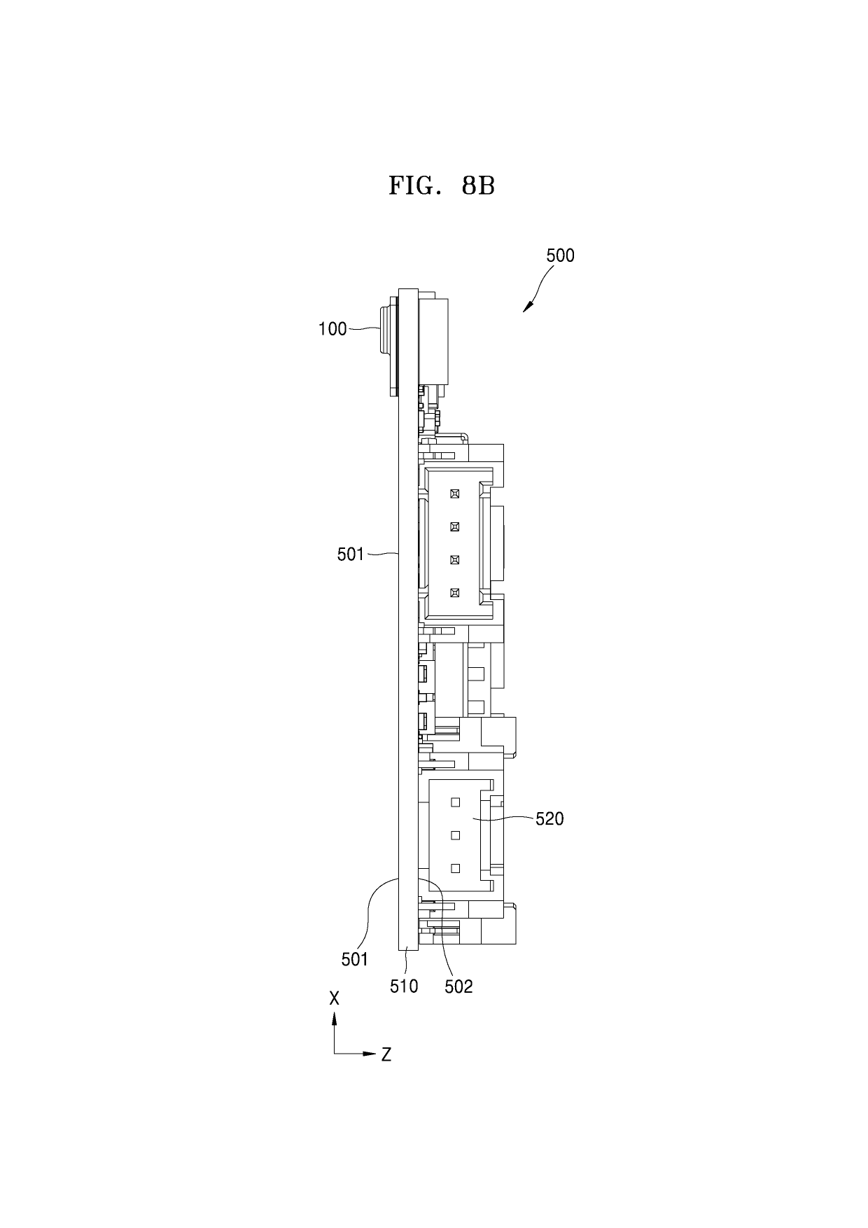

Referring to FIGS. 5 and 6, when the voice recognition module 10 according to an embodiment of the disclosure is disposed in the first cap door 300, the voice entry hole 110 for receiving a user's voice may be disposed at a location protruding from an uppermost surface of the first cap door 300, for example, an upper surface 310 of the first cap door 300. According to an embodiment of the disclosure, a plurality of voice entry holes 110 may be provided. For example, when the voice receiver 100 includes a plurality of voice receivers, for example, a first voice receiver 101 (see FIG. 8A) and a second voice receiver 102 (see FIG. 8A), the voice entry hole 110 may also include a plurality of voice entry holes, for example, a first voice entry hole 111 and a second voice entry hole 112, to correspond to the plurality of voice receivers 100.

For example, the voice entry hole 110 may be disposed in an upper case 120 coupled to an upper portion of the first cap door 300. According to an embodiment of the disclosure, an upper end of the refrigerator 1 that is visible from the outside may be the upper surface 310 of the first cap door 300 and an upper surface 121 of the upper case 120. In this case, the upper surface 121 of the upper case 120 may be disposed at a location protruding by a preset height difference H from the upper surface 310 of the first cap door 300.

When the voice entry hole 110 is disposed at a location protruding from the upper surface 310 of the first cap door 300, the voice entry hole 110 having an opening shape may be exposed to the outside. In addition, the upper surface 121 of the upper case 120 is disposed higher than the upper surface 310 of the first cap door 300, a height of the entire refrigerator 1 may increase. When the height of the refrigerator 1 increases, the height of the refrigerator 1 becomes greater than a height of an existing refrigerator 1 or a height of a space in which the refrigerator 1 is generally installed. Therefore, an installation space of the refrigerator 1 may be restricted. For example, due to a height difference, the refrigerator 1 may not be installed in a space where the refrigerator 1 is currently installed. Such restriction on the installation space of the refrigerator 1 may act as an important factor in consumers' product selection.

In order to minimize exposure of the voice entry hole 110 to the outside and an increase in the height of the refrigerator 1, the height difference H between the upper surface 121 of the upper case 120 and the upper surface 310 of the first cap door 300 may be designed to become minimal. When the height difference H between the upper surface 121 of the upper case 120 and the upper surface 310 of the first cap door 300 is limited as described above, a size of the voice entry hole 110 may be limited.

When the size of the voice entry hole 110 is limited, voice reception efficiency required to receive voice generated by a user may be limited. In order to offset the limitation of voice reception efficiency caused due to the limitation of the size of the voice entry hole 110, voice transmission efficiency of the voice entering through the voice entry hole 110 to the voice receiver 100 needs to be improved.

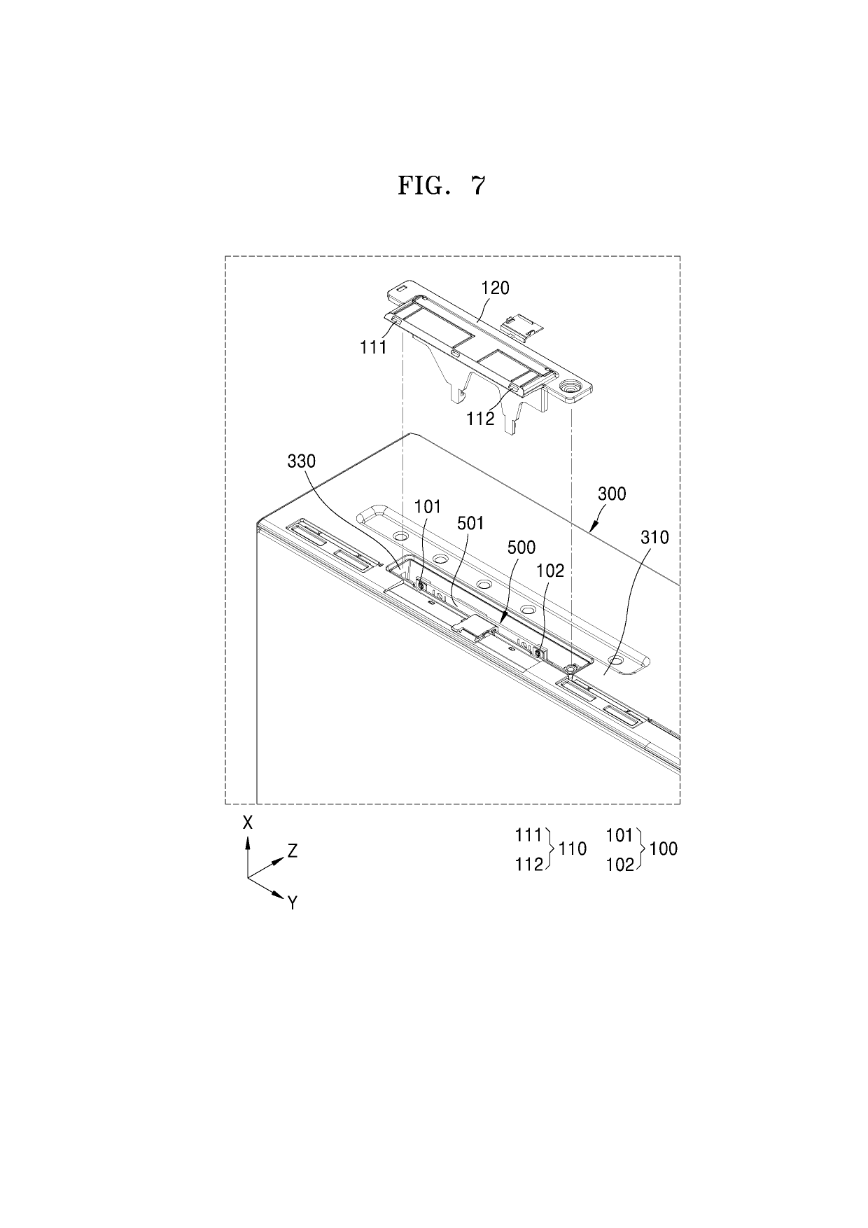

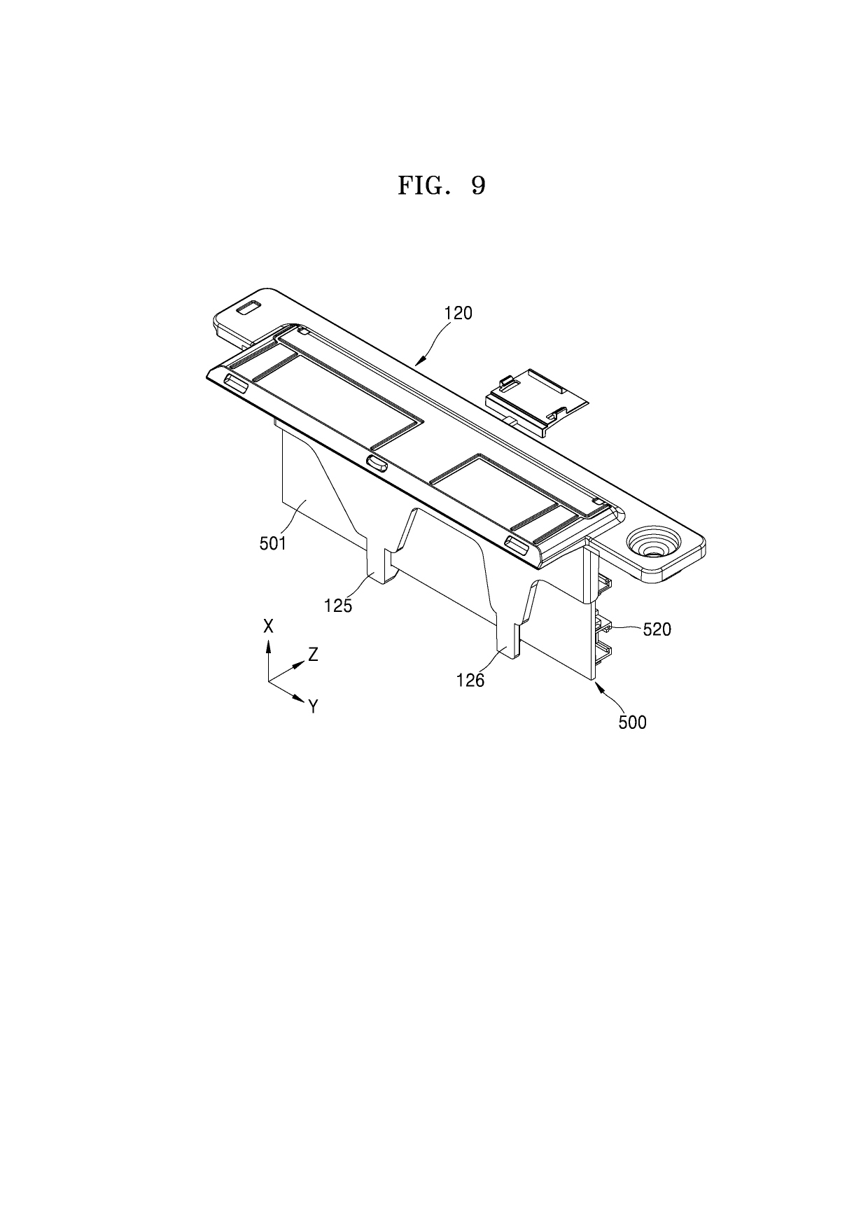

FIG. 7 is an exploded perspective view in which an upper case of a voice entry module in FIG. 5 is separated from a first cap door. FIG. 8A is a front perspective view of a printed board assembly (PBA) according to an embodiment of the disclosure. FIG. 8B is a side view of the PBA according to an embodiment of the disclosure. FIG. 9 is a perspective view of the voice entry module according to an embodiment of the disclosure.

Referring to FIGS. 7 through 9, the voice receiver 100 according to an embodiment of the disclosure may be disposed on one surface 501 of a PBA 500. The PBA 500 including the voice receiver 100 disposed thereon may be accommodated in a first accommodator 330 disposed in the first cap door 300.

The voice receiver 100 according to an embodiment of the disclosure may receive a voice command from a user. For example, the voice receiver 100 may include a microphone capable of receiving a voice command from a user. According to an embodiment of the disclosure, a gasket 150 may be disposed between the voice receiver 100 and the voice entry hole 110. The gasket 150 is a voice transmission member for transmitting a voice received through the voice entry hole 110 to the voice receiver 100. For example, the gasket 150 may be disposed to be attached to a front end of the voice receiver 100. However, the disclosure is not limited thereto, and the gasket 150 may be excluded in consideration of voice reception efficiency.

For example, a plurality of voice receivers 100 may be provided. Each of the plurality of voice receivers 100 may be arranged to be spaced apart from each other by a preset distance on the one surface 501 of the PBA 500. According to an embodiment of the disclosure, the plurality of voice receivers 100 may include the first voice receiver 101 and the second voice receiver 102. The first voice receiver 101 and the second voice receiver 102 may be arranged to be spaced apart from each other by a preset distance on the one surface 501 of the PBA 500. For example, the first voice receiver 101 and the second voice receiver 102 may be arranged to be spaced apart from each other by a preset distance in a second direction (Y direction), for example, a width direction of the door 6, on the one surface 501 of the PBA 500. However, the disclosure is not limited thereto, and a single voice receiver 100 may be provided or a plurality of voice receivers 100 may include three or more voice receivers.

According to an embodiment of the disclosure, the voice receiver 100 may be disposed at an uppermost end on the one surface 501 of the PBA 500 in a first direction (X direction), for example, a lengthwise direction of the door 6. As the voice receiver 100 is disposed at the uppermost end of the PBA 500 along the first direction (X direction), the PBA 500 may be prevented from being positioned at a location protruding from the uppermost surface of the first cap door 300, for example, from the upper surface 310 of the first cap door 300.

According to an embodiment of the disclosure, the PBA 500 may include a printed circuit board 510 and one or more electronic components 520 arranged on the printed circuit board 510. For example, the one or more electronic components 520 may include one or more of a communication chip, a memory, and a CPU. According to an embodiment of the disclosure, the one or more electronic components 520 may be arranged on another surface 502 of the PBA 500. In this case, the one or more electronic components 520 may have a preset height along a third direction (Z direction), for example, along the thickness direction of the door 6.

The PBA 500 according to an embodiment of the disclosure may be supported by the upper case 120. For example, the upper case 120 may include a first support 125 and a second support 126 for supporting the PBA 500. The first support 125 and the second support 126 may each extend in the first direction (X direction), for example, the lengthwise direction of the door 6. In this case, the first support 125 and the second support 126 may be arranged to be spaced apart from each other in the second direction (Y direction), for example, the width direction of the door 6. The one surface 501 of the PBA 500 may be supported by the first support 125 and the second support 126 by fitting thereonto. Accordingly, the PBA 500 may be fixedly coupled to the upper case 120.

The upper case 120 according to an embodiment of the disclosure may be coupled to an upper portion of the first accommodator 330 provided in the first cap door 300. Accordingly, the PBA 500 may be accommodated in the first accommodator 330. As the PBA 500 is accommodated in the first accommodator 330, the voice receiver 100 disposed on the one surface 501 of the PBA 500 may also be accommodated in the first accommodator 330 disposed in the first cap door 300.

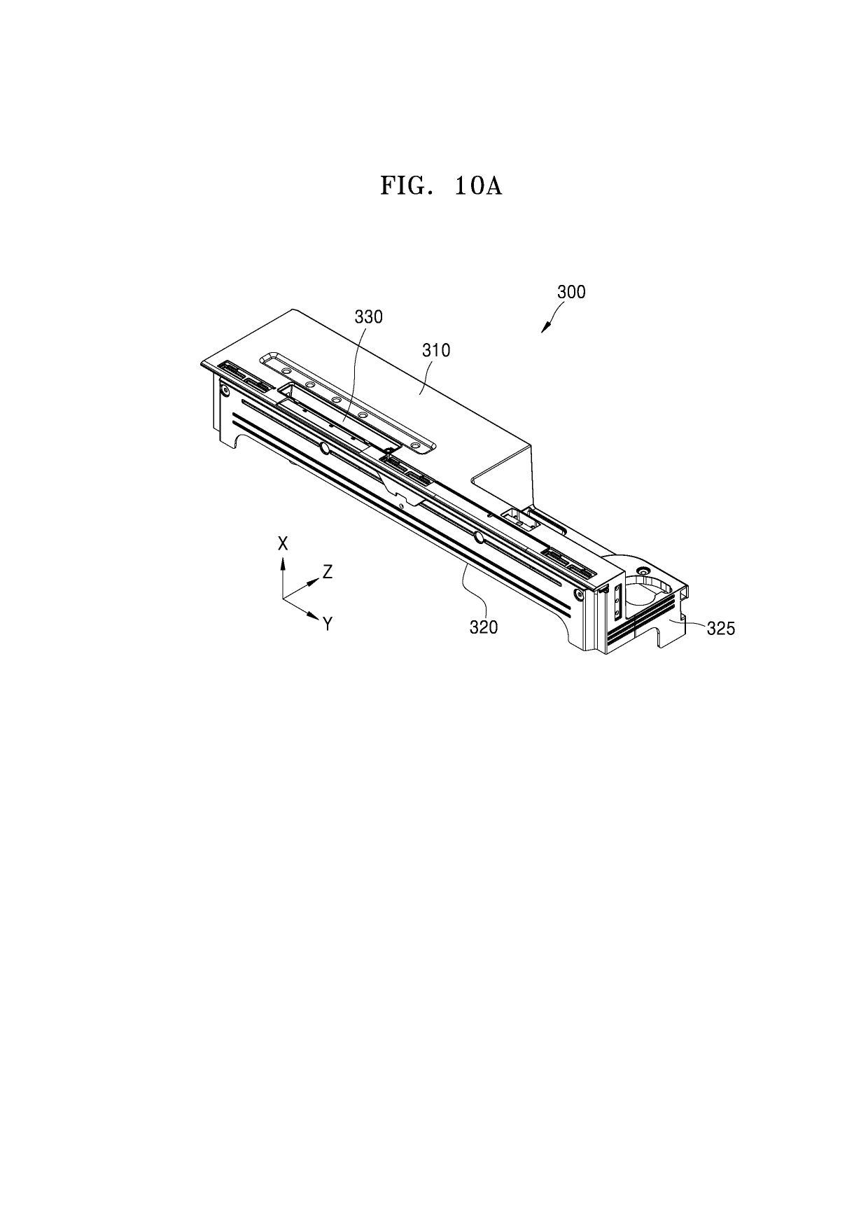

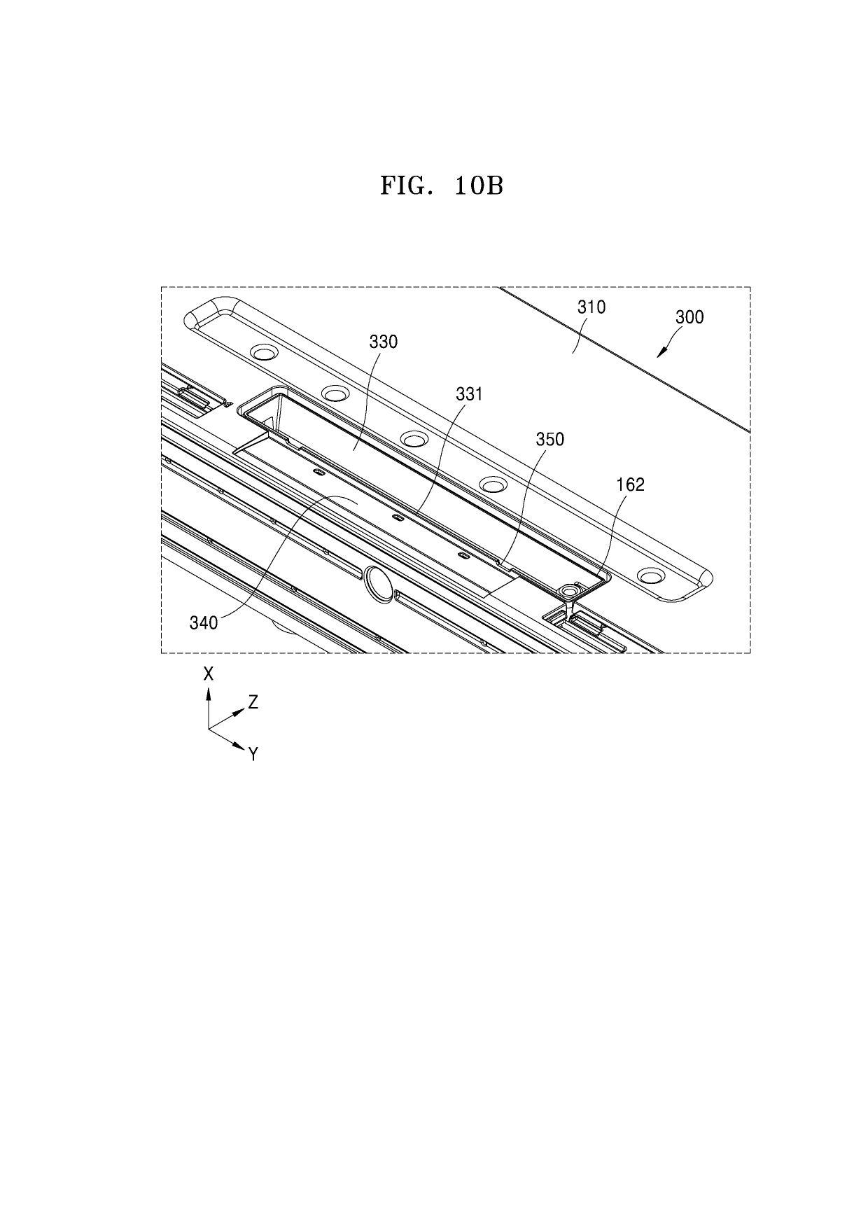

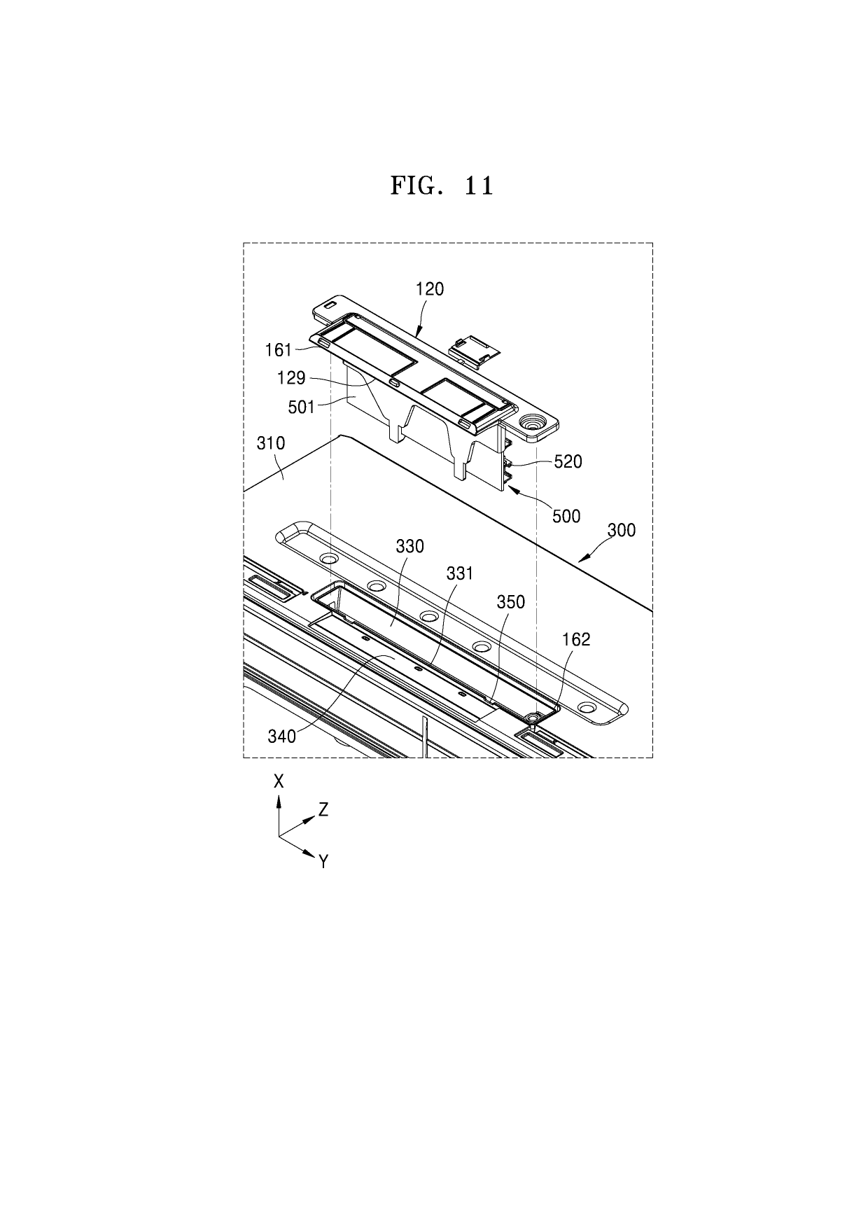

FIG. 10A is a perspective view of the first cap door 300 according to an embodiment of the disclosure. FIG. 10B is a partial perspective view of the first cap door 300 according to an embodiment of the disclosure. FIG. 11 is an exploded perspective view in which the voice entry module according to an embodiment of the disclosure is separated from the first cap door 300.

Referring to FIGS. 7, 10A, 10B, and 11, the first cap door 300 according to an embodiment of the disclosure may be disposed to be coupled to the upper portion of the door 6, as shown in FIG. 4. For example, a lower portion 320 and a side portion 325 of the first cap door 300 may have shapes corresponding to the upper portion of the door 6 so that they may be coupled to the upper portion of the door 6.

According to an embodiment of the disclosure, when the first cap door 300 is coupled to the upper portion of the door 6, the upper surface 310 of the first cap door 300 may be defined as the upper end of the refrigerator 1. Because the first cap door 300 may be an outer casing exposed to the outside, the first cap door 300 may include a material that is easy to design and manufacture so as to create a sophisticated appearance. For example, the first cap door 300 may include a plastic material such as polypropylene (PP) or polystyrene (PS). However, the disclosure is not limited thereto, and the first cap door 300 may include another material such as tempered glass or metal.

According to an embodiment of the disclosure, the first accommodator 330 may be disposed in the first cap door 300. The first accommodator 330 may have an accommodating space for accommodating the PBA 500. According to an embodiment of the disclosure, when the PBA 500 is disposed in the first accommodator 330, the one surface 501 of the PBA 500 on which the voice receiver 100 is disposed may be disposed parallel to the front surface 601 of the door 6 extending along one plane, for example, to an XY plane.

According to an embodiment of the disclosure, a stepped portion 340 may be disposed on the upper surface 310 of the first cap door 300. The stepped portion 340 may form a voice entry path through which the voice received through the voice entry hole 110 may pass. The stepped portion 340 may be formed at a location lower than the upper surface 310 of the first cap door 300 in the first direction (X direction), for example, the lengthwise direction of the door 6. The stepped portion 340 may be disposed between the door 6 and the first accommodator 330.

According to an embodiment of the disclosure, a voice entry groove portion 350 may be disposed between the first accommodator 330 and the stepped portion 340. The voice entry groove portion 350 may be disposed on a side wall 331 of the first accommodator 330 corresponding to the voice receiver 100. In other words, the voice entry groove portion 350 may be disposed on the side wall 331 of the first accommodator 330 disposed between the stepped portion 340 and the voice receiver 100.

As the voice entry groove portion 350 is disposed on the side wall 331 of the first accommodator 330 corresponding to the voice receiver 100, the voice transmitted through the stepped portion 340 may be transmitted to the voice receiver 100 through the voice entry groove portion 350. In this case, the voice receiver 100 may not be disposed at a location protruding from the uppermost surface of the first cap door 300, for example, the upper surface 310 of the first cap door 300. In other words, when the voice receiver 100 is not disposed at the location protruding from the uppermost surface of the first cap door 300, for example, the upper surface 310 of the first cap door 300, the voice receiver 100 may receive the voice received through the voice entry hole 110.

According to an embodiment of the disclosure, the upper case 120 may include a first fastening portion 161, and the first cap door 300 may include a second fastening portion 162 corresponding to the first fastening portion 161. For example, the first fastening portion 161 may be disposed on a lower surface 129 of the upper case 120. In this case, the second fastening portion 162 may be disposed on the upper surface 310 of the first cap door 300. For example, the second fastening portion 162 may have a groove shape extending along a perimeter of the first accommodator 330. In this case, the first fastening portion 161 may have a protruding shape corresponding to the second fastening portion 162. As the first fastening portion 161 is inserted into and fastened to the second fastening portion 162, the upper case 120 may be coupled to the first cap door 300 so as to be aligned with respect to the first cap door 300. In the above-described embodiment of the disclosure, the first fastening portion 161 and the second fastening portion 162 are described as having a groove shape and a protrusion shape corresponding thereto. However, the disclosure is not limited thereto. The first fastening portion 161 and the second fastening portion 162 may be replaced with fastening members having an arbitrary location guide function capable of aligning the upper case 120 with respect to the first cap door 300.

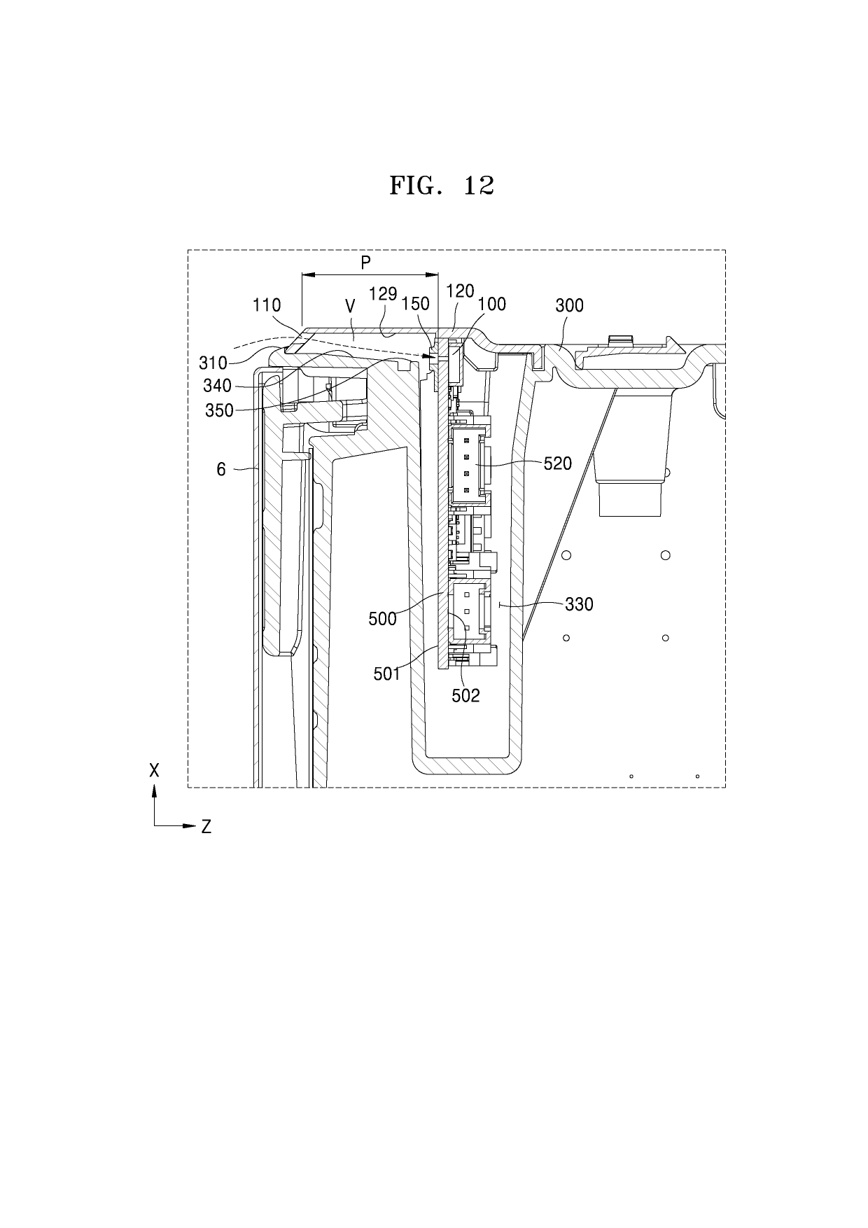

According to an embodiment of the disclosure, as the upper case 120 is coupled to the first cap door 300 so as to be aligned with respect to the first cap door 300, the PBA 500 supported by the upper case 120 and the voice receiver 100 disposed on the one surface 501 of the PBA 500 may also be aligned relative to the first accommodator 330. Accordingly, a voice entry path V (see FIG. 12) extending along the voice entry hole 110, the stepped portion 340, and the voice entry groove portion 350 may be aligned with the voice receiver 100 so as to correspond to each other.

FIG. 12 is a partial cross-sectional view of the door 6 taken along line A-A' shown in FIG. 5.

Referring to FIG. 5 and 12, the voice entry hole 110 according to an embodiment of the disclosure may be exposed to the outside so as to receive a user's voice. For example, the voice entry hole 110 may be disposed in the upper case 120. The voice received through the voice entry hole 110 may be transmitted to the voice receiver 100 through the voice entry path V extending from the voice entry hole 110 to the voice receiver 100. For example, when a plurality of voice entry holes 110 and a plurality of voice receivers 100 are provided, a plurality of voice entry paths V corresponding thereto may also be provided. For example, when the first voice entry hole 111 and the first voice receiver 101 are arranged to correspond to each other, a first voice entry path may be formed between the first voice entry hole 111 and the first voice receiver 101. In addition, when the second voice entry hole 112 and the second voice receiver 102 are arranged to correspond to each other, a second voice entry path may be formed between the second voice entry hole 112 and the second voice receiver 102.

The voice entry path V according to an embodiment of the disclosure may be formed in a separation space formed between the upper case 120 and the first cap door 300. For example, the stepped portion 340 may be disposed on the upper surface 310 of the first cap door 300. In addition, the voice entry groove portion 350 may be disposed between the first accommodator 330 and the stepped portion 340. The stepped portion 340 and the voice entry groove portion 350 may be formed at locations lower than the upper surface 310 of the first cap door 300 in the first direction (X direction), for example, the lengthwise direction of the door 6. The lower surface 129 of the upper case 120 may be disposed over the stepped portion 340 and the voice entry groove portion 350 with a preset interval therebetween in the first direction (X direction), for example, the lengthwise direction of the door 6.

The voice entry path V according to an embodiment of the disclosure may extend from the voice entry hole 110 to the voice receiver 100 in a third direction (Z direction), for example, in the thickness direction of the door 6. In order to improve voice-reception efficiency of the voice that is transmitted from the voice entry hole 110 to the voice receiver 100, a length P of the voice entry path V in the third direction (Z direction) needs to be reduced. According to an embodiment of the disclosure, the voice receiver 100 may be disposed on the one surface 501 of the PBA 500, other than the other surface 502 of the PBA 500 on which one or more electronic components 520 are disposed, the one surface 501 being opposite to the other surface 502. Accordingly, a length P of the voice entry path V may be formed to be less than a height of the one or more electronic components 520.

As the voice entry path V according to an embodiment of the disclosure extends in the third direction (Z direction), for example, in the thickness direction of the door 6, the voice receiver 100 may be disposed to face the voice entry hole 110 in the third direction (Z direction), for example, in the thickness direction of the door 6. As the voice receiver 100 is disposed to face the voice entry hole 110 in the third direction (Z direction), for example, in the thickness direction of the door 6, voice transmission efficiency of the voice entering through the voice entry hole 110 being transmitted to the voice receiver 100 may be improved.

As shown in FIG. 6, in order to minimize exposure of the voice entry hole 110 to the outside and an increase in the height of the refrigerator 1, the height difference H between the upper surface 121 of the upper case 120 and the upper surface 310 of the first cap door 300 may be designed to become minimal. When the height difference H between the upper surface 121 of the upper case 120 and the upper surface 310 of the first cap door 300 is limited as described above, the size of the voice entry hole 110 may be limited. When the size of the voice entry hole 110 is limited, voice reception efficiency for voice may be reduced. In this case, as the voice receiver 100 is disposed to face the voice entry hole 110 in the third direction (Z direction), for example, in the thickness direction of the door 6, voice reception efficiency that may occur due to the limitation of the size of the voice entry hole 110 may be offset.

Accordingly, the refrigerator 1 according to an embodiment of the disclosure may foster an aesthetic appeal by minimizing the exposure of the sound entry hole 110 to the outside. In addition, the refrigerator 1 according to an embodiment of the disclosure may secure design convenience by minimizing the height difference H between the upper surface 121 of the upper case 120 and the upper surface 310 of the first cap door 300. Moreover, the refrigerator 1 according to an embodiment of the disclosure may offset the voice reception efficiency that may occur due to the limitation of the size of the voice entry hole 110.

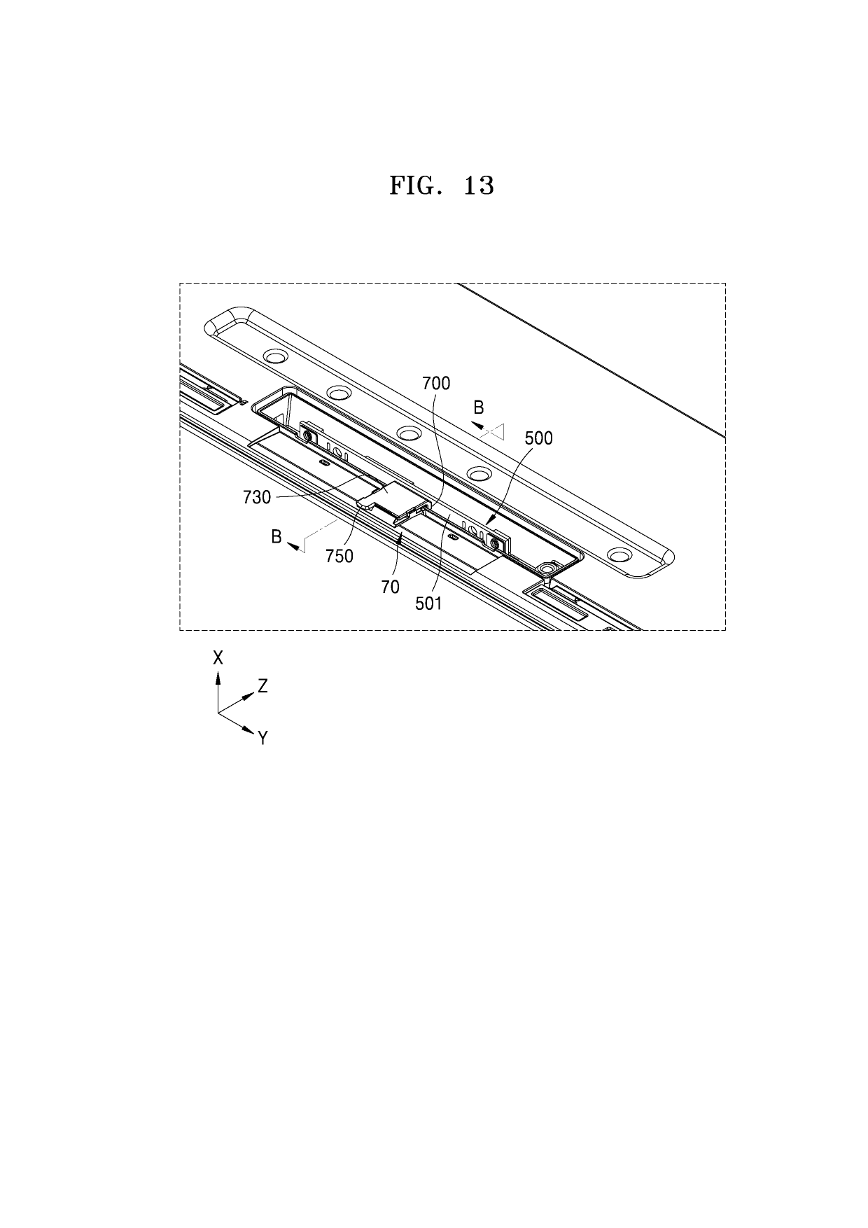

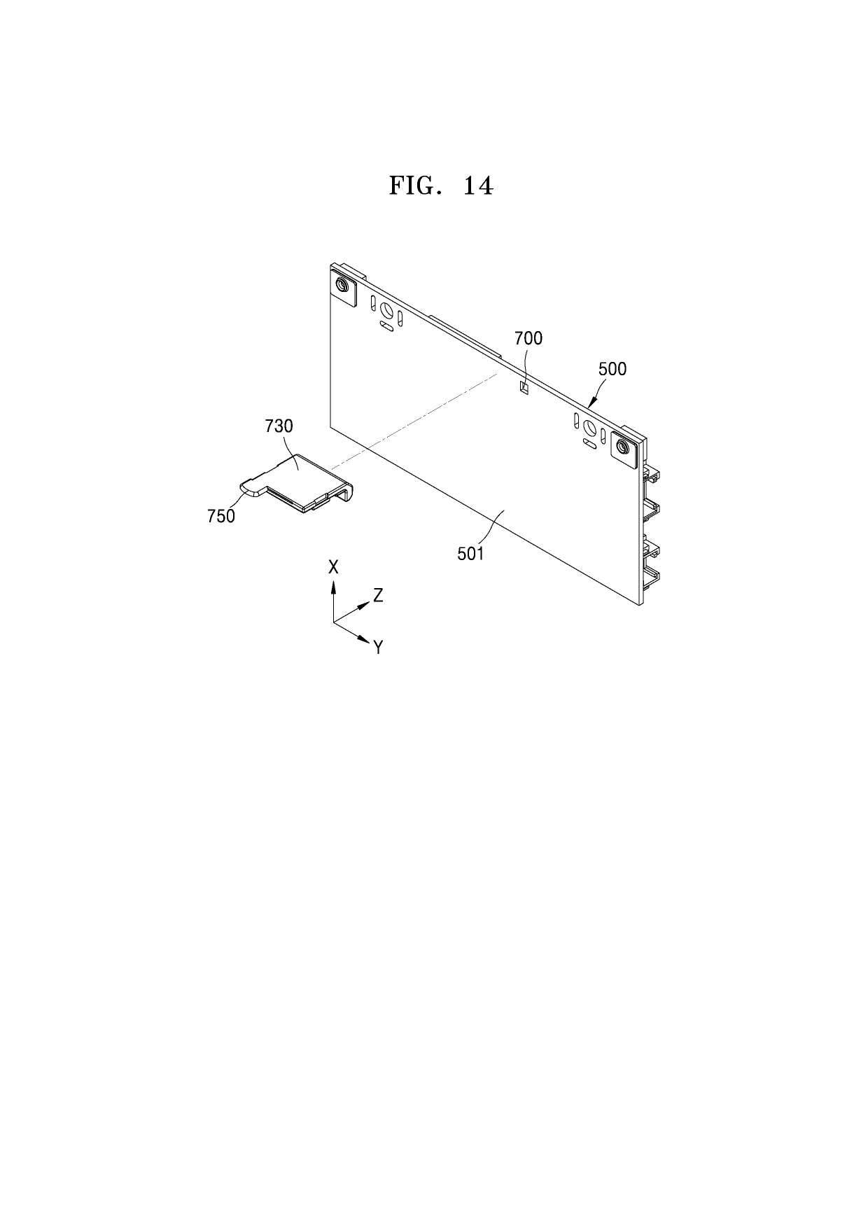

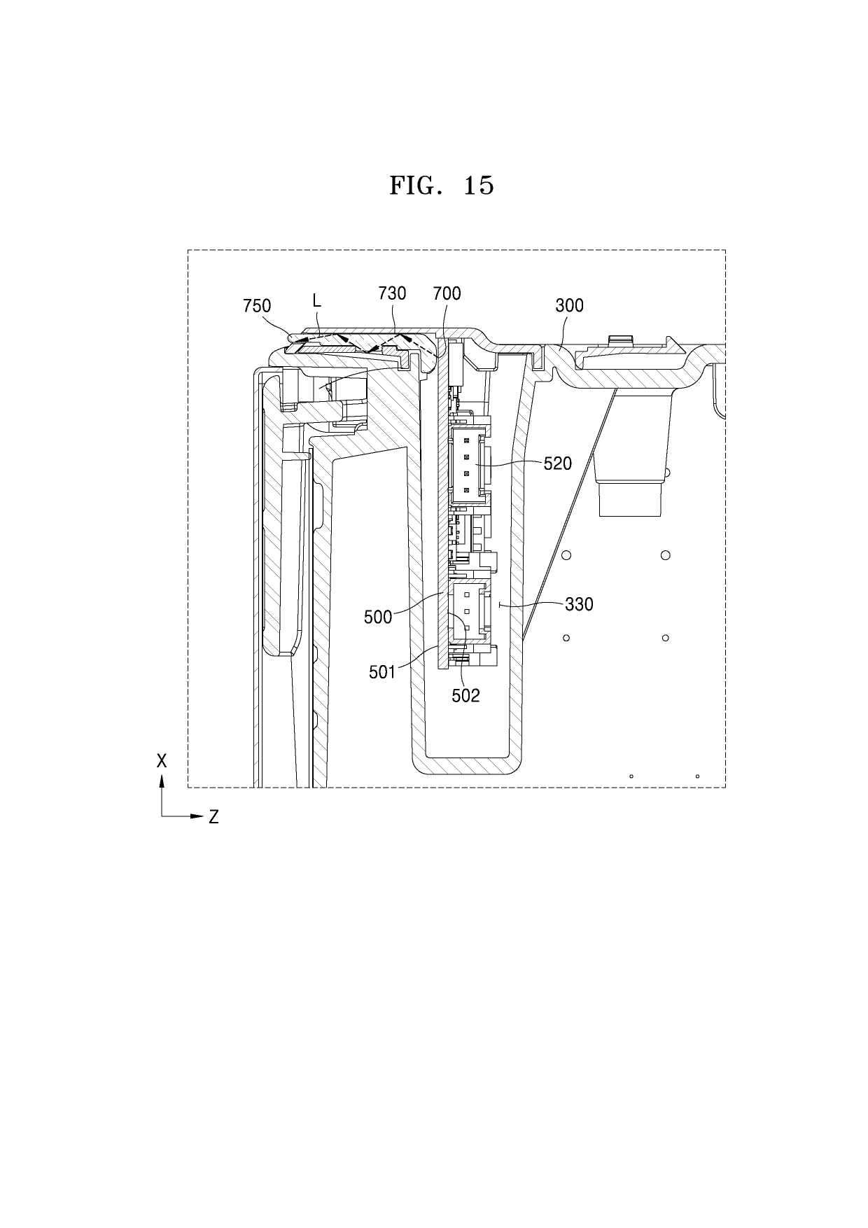

FIG. 13 is a partial perspective view of a door according to an embodiment of the disclosure. FIG. 14 is an exploded perspective view of a PBA according to an embodiment of the disclosure. FIG. 15 is a partial cross-sectional view of the door taken along line B-B' shown in FIG. 13.

Referring to FIGS. 2, 5, 13, 14, and 15, an indicator module 70 according to an embodiment of the disclosure may display a voice reception status of the voice receiver 100. For example, in order to protect the user's personal information, it is necessary for the user to be aware of a state in which the user's voice command is received by the voice receiver 100. For example, when the user's voice command is received by the voice receiver 100, a light display may be output by the indicator module 70. On the other hand, when the user's voice command is not received by the voice receiver 100, a light display may not be output by the indicator module 70. The user may determine whether the user's voice command is received by the voice receiver 100, by checking the state in which the light display is output by the indicator module 70.

The indicator module 70 according to an embodiment of the disclosure may include one or more light-emitting elements 700, a light guide plate 730 that moves light emitted by the one or more light-emitting elements 700 along a preset path, and a light outputter 750 that exposes the light moved along the light guide plate 730 to the outside. According to an embodiment of the disclosure, the one or more light-emitting elements 700 may generate light having a preset wavelength. For example, the one or more light-emitting elements 700 may be turned on/off under a control by the processor 90.

For example, when a voice is received from the voice receiver 100, the processor 90 may control the one or more light-emitting elements 700 to be turned on. Accordingly, the one or more light-emitting elements 700 may generate light having a preset wavelength. On the other hand, when a voice is interrupted from being received from the voice receiver 100, the processor 90 may control the one or more light-emitting elements 700 to be turned off. Accordingly, the one or more light-emitting elements 700 may not generate light having a preset wavelength.

According to an embodiment of the disclosure, a plurality of light-emitting elements 700 may be provided. When a plurality of light-emitting elements 700 are provided, light beams L generated by the plurality of light-emitting elements 700 may have different wavelengths. Not only may a voice be received from the voice receiver 100 by using the light beams L of different wavelengths generated by the plurality of light-emitting elements 700, but a plurality of operating states of the refrigerator 1 may also be displayed.

According to an embodiment of the disclosure, the one or more light-emitting elements 700 may be arranged on the one surface 501 of the PBA 500. As the one or more light-emitting elements 700 are arranged on the one surface 501 of the PBA 500, an assembly space for arranging the one or more light-emitting elements 700 may be reduced. Therefore, design convenience and space efficiency of the refrigerator 1 may be improved.

According to an embodiment of the disclosure, the light outputter 750 may be disposed in a light output hole 140 provided in the upper case 120, and thus may output the light beams L to the outside. For example, the light output hole 140 may be disposed adjacent to the voice entry hole 110 to achieve design convenience and indication of a voice reception state. For example, when a plurality of voice entry holes 110 are provided and include the first voice entry hole 111 and the second voice entry hole 112, the light output hole 140 may be disposed between the first voice entry hole 111 and the second voice entry hole 112.

The light guide plate 730 according to an embodiment of the disclosure may be connected from the one or more light-emitting elements 700 to the light output unit 750. Accordingly, the light guide plate 730 may transmit the light beams L generated by the one or more light-emitting elements 700 to the light output unit 750. According to an embodiment of the disclosure, one end of the light guide plate 730 may be connected to the one or more light-emitting elements 700, and anther end thereof may be connected to the light output unit 750. For example, the light guide plate 730 and the light output unit 750 may be integrally formed with each other. A shielding member capable of preventing light from being emitted to the outside of the light guide plate 730 may be disposed on the perimeter of the light guide plate 730. Accordingly, while the light beams L generated by the one or more light-emitting elements 700 are being transmitted through the light output unit 730, light emission to the outside of the light guide plate 730 may be minimized.

According to an embodiment of the disclosure, the light outputter 750 may have a smaller cross-sectional area than the light guide plate 730. Because the light outputter 750 has a smaller cross-sectional area than the light guide plate 730, light transmitted through the light guide plate 730 may be concentrated at one end of the light outputter 750. Accordingly, the light beams L transmitted through the light guide plate 730 may be collected at the light outputter 750 and thus may be emitted as high-illuminance light to the outside.

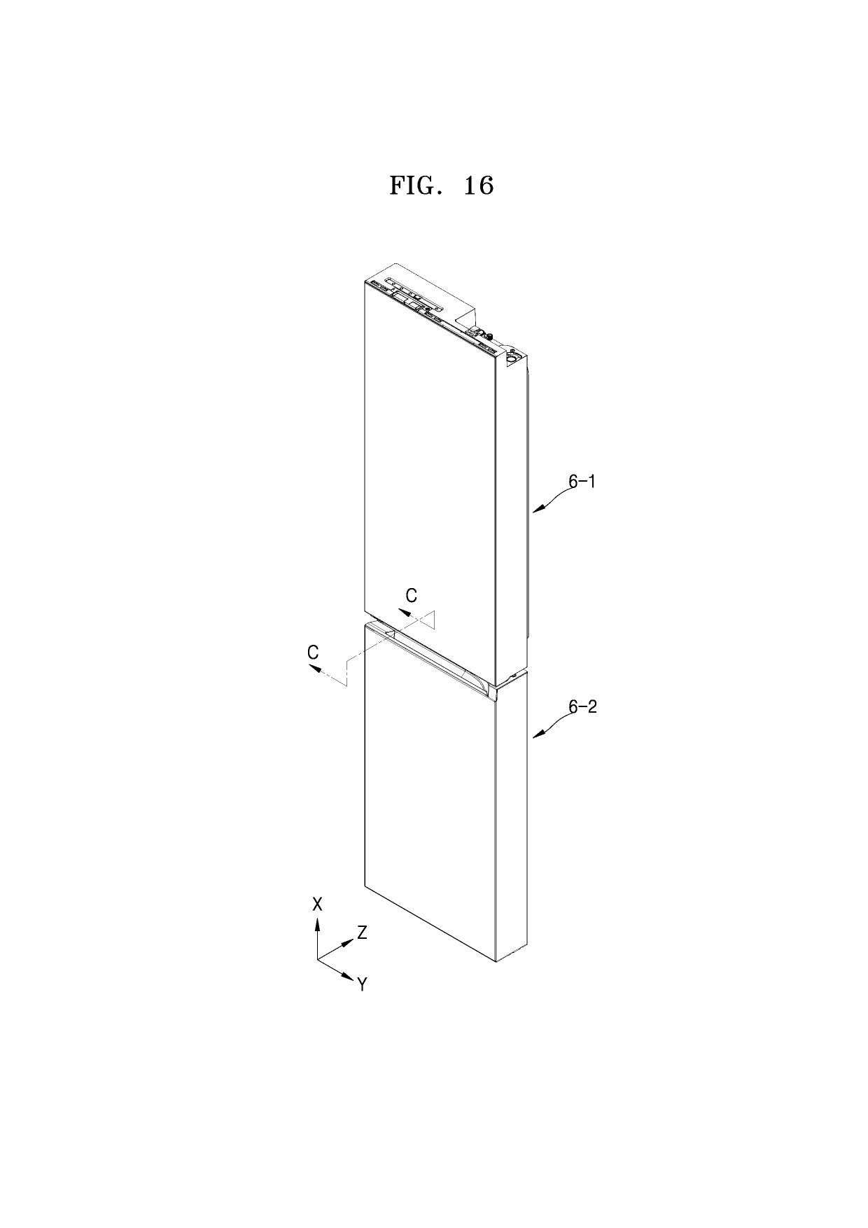

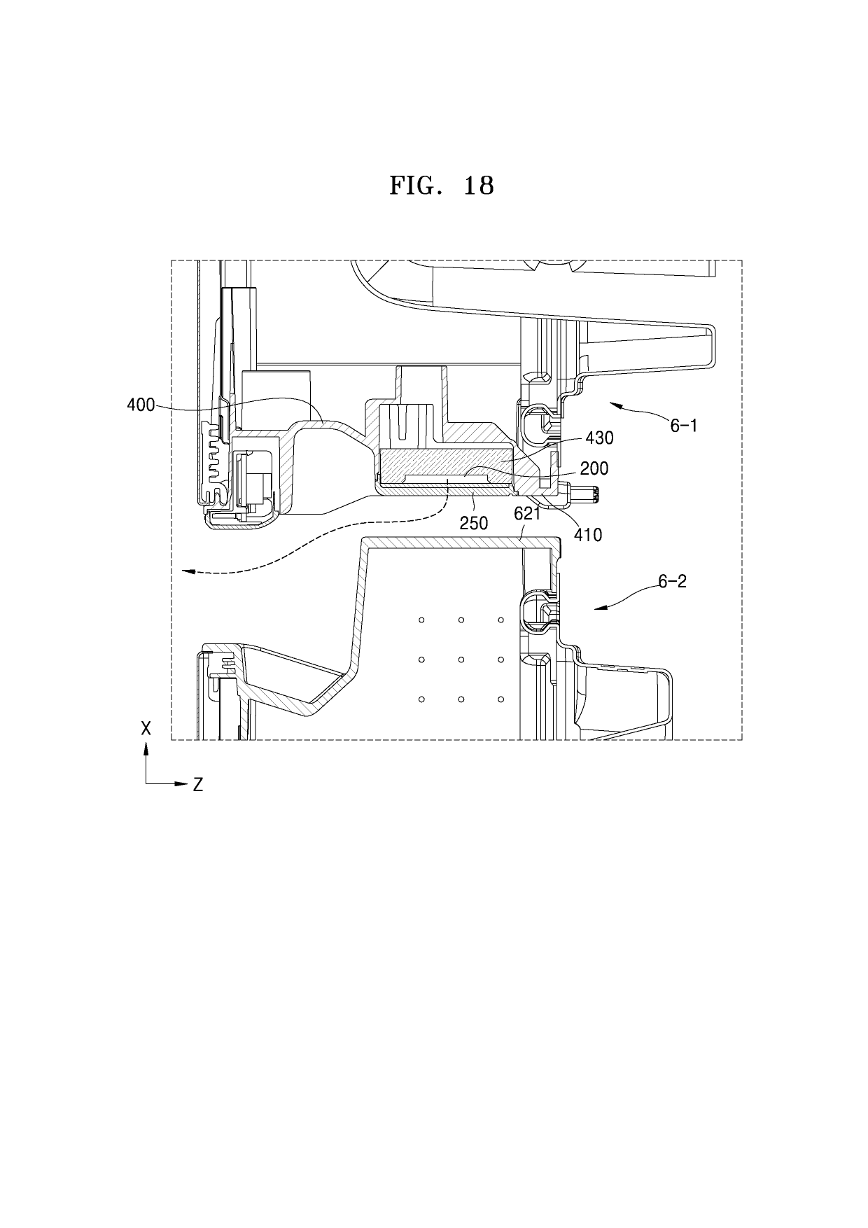

FIG. 16 is a perspective view of the door 6 according to an embodiment of the disclosure. FIG. 17A is a perspective view of the sound output module 20 according to an embodiment of the disclosure. FIG. 17B is a perspective view of the sound output module 20 according to an embodiment of the disclosure. FIG. 18 is a partial cross-sectional view of the door 6 taken along line C-C shown in FIG. 16.

Referring to FIGS. 2, 4, 16, 17, and 18, the sound outputter 200 according to an embodiment of the disclosure may output sound for informing a user of an operating status and necessary information of the refrigerator 1. For example, the processor 90 may control the output of sound having a preset wavelength from the sound outputter 200 through a communication interface (not shown), after determining the operating status and necessary information of the refrigerator 1.

The sound outputter 200 for outputting sound to the outside needs to be disposed at a location exposed to the outside. For example, an upper door 6-1 may be disposed to be spaced apart from a lower door 6-2 by a preset gap G, although a lower end of the door (6), for example, a lower end of the upper door 6-1, is difficult to be recognized by the user from the outside, while the user is using the refrigerator 1. Accordingly, when the sound outputter 200 is disposed on a lower end of the upper door 6-1, the sound outputter 200 is not directly visible from the outside, and thus not only may an aesthetic appeal be secured, but also a functional feature of outputting sound to the outside may be secured. However, the disclosure is not limited thereto, and the sound outputter 200 may be disposed on a lower end of the lower door 6-2. In this case, the sound outputter 200 may be disposed to be spaced apart from the ground by a preset interval between them.

According to an embodiment of the disclosure, the second cap door 400 may be disposed on a lower portion of the upper door 6-1. The lower end of the upper door 6-1 exposed to the outside may be a lower surface 410 of the second cap door 400. The second accommodator 430 according to an embodiment of the disclosure may be disposed on the second cap door 400. For example, the second accommodator 430 may have an accommodating space provided in a shape of a groove that is concave from the lower surface 410 of the second cap door 400 in the first direction (X direction), for example, in the lengthwise direction of the upper door 6-1.

According to an embodiment of the disclosure, the sound output module 20 may be disposed to be accommodated in the second accommodator 430. For example, the sound outputter 200 may be disposed to be supported by the second accommodator 430. In this case, a sound outputter case 250 may be disposed on a front surface of the sound outputter 200. According to an embodiment of the disclosure, the sound outputter case 250 may include sound discharge holes 253 through which sound generated by the sound outputter 200 may be output.

The sound outputter 200 according to an embodiment of the disclosure may be disposed on the same plane (YZ plane) as the lower surface 410 of the second cap door 400 forming the lower end of the upper door 6-1. Because the sound outputter 200 is disposed on the same plane (YZ plane) as the lower surface 410 of the second cap door 400, the sound generated by the sound outputter 200 may be output in the first direction (X direction), for example, in the lengthwise direction of the upper door 6-1. The sound output by the sound outputter 200 may be reflected by an upper end 621 of the lower door 6-2 and output to the outside.

One aspect of the disclosure provides a refrigerator having improved design convenience by minimizing a protrusion height by arranging, on an upper cap door, a voice receiver for receiving a user's voice.

One aspect of the disclosure provides a refrigerator having improved aesthetic appeal by minimizing exposure of a voice entry hole for receiving a user's voice to the outside.

One aspect of the disclosure provides a refrigerator having improved voice reception efficiency of a user's voice by arranging a voice receiver on one surface of a printed circuit board.

One aspect of the disclosure provides a refrigerator that uses an indicator module to inform a user of a state in which a voice is received by a voice receiver.

One aspect of the disclosure provides a refrigerator in which a sound outputter for transmitting information about the refrigerator is disposed in a lower cab door.

One aspect of the disclosure provides a refrigerator having improved aesthetic appeal and improved manufacturing convenience by minimizing exposure of a sound outputter for emitting sound to the outside.

The technical problems to be addressed in this disclosure are not limited to the above-mentioned technical problems, and other technical problems not mentioned will be clearly understood by a person skilled in the art to which the disclosure pertains from the following description.

A refrigerator according to an embodiment of the disclosure may include a storage compartment providing a storage space, a door opening or closing the storage compartment, a first cap door disposed in an upper portion of the door, a first accommodator disposed in the first cap door, a printed board assembly (PBA) disposed in the first accommodator and having a flat shape extending along one plane, and a voice receiver disposed on one surface of the PBA.

The refrigerator may further include a voice entry hole having an opening shape, and a voice entry path extending from the voice entry hole to the voice receiver.

The voice receiver may be disposed to face the voice entry hole in a thickness direction of the door.

One surface of the PBA may be disposed parallel to a front surface of the door.

The refrigerator may include a gasket disposed between the voice entry hole and the voice receiver.

The refrigerator further include an upper case coupled to an upper portion of the first accommodator, and the voice entry path may be provided by a separation space between a stepped portion disposed in an upper portion of the first cap door and a lower surface of the upper case.

The refrigerator may further include a first fastening portion disposed on the upper case, and a second fastening portion disposed on the first cap door, and the upper case and the first cap door may be aligned and joined at a preset location by coupling of the first fastening portion and the second fastening portion.

The voice receiver may be provided in plurality, and a plurality of voice receivers may be arranged to be spaced apart from each other by a preset interval on one surface of the PBA.

The refrigerator may further include a plurality of voice entry holes in opening shapes individually corresponding to the plurality of voice receivers, and a plurality of voice entry paths respectively extending from the plurality of voice entry holes to the plurality of voice receivers.

The plurality of voice receivers may include a first voice receiver and a second voice receiver, and the first voice receiver and a second voice receiver may be arranged to be spaced apart from each other with a preset interval in a width direction of the door.

The refrigerator may further include a voice recognizer configured to recognize a voice received from the voice receiver.

The refrigerator may further include an indicator module configured to indicate a voice reception status of the voice receiver.

The indicator module may include one or more light-emitting elements, a light guide plate that moves light emitted by the one or more light-emitting elements along a preset path, and a light outputter that exposes the light moved along the light guide plate to the outside.

The one or more light-emitting elements may be arranged on one surface of the PBA.

The refrigerator may further include a processor configured to control the one or more light-emitting elements, and the processor may control on/off of the one or more light-emitting elements according to whether the voice receiver receives a voice.

The refrigerator may further include an upper case coupled to an upper portion of the first accommodator and including a light output hole, and the light outputter may be disposed in the light output hole and expose the light to the outside.

The refrigerator may further include a second cap door disposed in a lower portion of the door, a second accommodator disposed in the second cap door, and a sound outputter disposed on the second accommodator.

The sound outputter may be disposed on the same plane as a lower surface of the second cap door.

A refrigerator according to an aspect of the disclosure may have improved design convenience by minimizing a protrusion height by arranging, on an upper cap door, a voice receiver for receiving a user's voice.

A refrigerator according to an aspect of the disclosure may have improved aesthetic appeal by minimizing exposure of a voice entry hole for receiving a user's voice to the outside.

A refrigerator according to an aspect of the disclosure may have improved voice reception efficiency of a user's voice by arranging a voice receiver on one surface of a printed circuit board.

A refrigerator according to an aspect of the disclosure may use an indicator module to inform a user of a state in which a voice is received by a voice receiver.

A refrigerator according to an aspect of the disclosure may include a sound outputter for transmitting information about the refrigerator, the sound outputter being disposed in a lower cab door, to thereby minimize exposure of the sound outputter to the outside, leading to improved aesthetic appeal and improved manufacturing convenience.

Although embodiments of a refrigerator have been described above with reference to the drawings to help understanding, the illustrated embodiments are only examples, and those skill in the art will understand that various modifications to the illustrated embodiments and other equivalent embodiments are possible. Therefore, the scope of the disclosure should be determined by the accompanying claims.

1. A refrigerator comprising:
a storage compartment providing a storage space;
a door to open or to close the storage compartment;
a first cap door disposed in an upper portion of the door;
a first accommodator to be disposed in the first cap door;
a printed board assembly (PBA), to be disposed in the first accommodator, having a flat shape extending along one plane; and
a voice receiver to be disposed on one surface of the PBA.

2. The refrigerator of claim 1, further comprising:
a voice entry hole having an opening; and
a voice entry path extending from the voice entry hole to the voice receiver.

3. The refrigerator of claim 2, wherein the voice receiver is disposed to face the voice entry hole along a thickness direction of the door.

4. The refrigerator of claim 3, wherein one surface of the PBA is disposed parallel to a front surface of the door.

5. The refrigerator of claim 2, further comprising a gasket disposed between the voice entry hole and the voice receiver.

6. The refrigerator of claim 2, further comprising an upper case coupleable to an upper portion of the first accommodator,
wherein the voice entry path is provided by a separation space between a stepped portion disposed in an upper portion of the first cap door and a lower surface of the upper case.

7. The refrigerator of claim 2, further comprising:
a first fastening portion disposed on the upper case; and
a second fastening portion disposed on the first cap door,
wherein the upper case and the first cap door are aligned and joined at a preset location by coupling of the first fastening portion and the second fastening portion.

8. The refrigerator of claim 1, wherein the voice receiver is provided in plurality, and a plurality of voice receivers and are arranged to be spaced apart from each other by a preset interval on one surface of the PBA.

9. The refrigerator of claim 8, further comprising:
a plurality of voice entry holes and in a form of openings individually corresponding to the plurality of voice receivers; and
a plurality of voice entry paths respectively extending from the plurality of voice entry holes to the plurality of voice receivers.

10. The refrigerator of claim 8, wherein the plurality of voice receivers include a first voice receiver and a second voice receiver , and the first voice receiver and a second voice receiver are arranged to be spaced apart from each other by a preset interval in a width direction of the door.

11. The refrigerator of claim 1, further comprising a voice recognizer configured to recognize a voice received from the voice receiver.

12. The refrigerator of claim 1, further comprising an indicator module configured to indicate a voice reception status of the voice receiver.

13. The refrigerator of claim 12, wherein the indicator module comprises:
one or more light-emitting elements;
a light guide plate to guide light emitted by the one or more light-emitting elements along a preset path; and
a light outputter to output the light that has been guided along the light guide plate.

14. The refrigerator of claim 13, wherein the one or more light-emitting elements are arranged on one surface of the PBA.

15. The refrigerator of claim 13, further comprising a processor configured to control the one or more light-emitting elements,
wherein the processor is configured to control on/off of the one or more light-emitting elements according to whether the voice receiver receives a voice.

16. The refrigerator of claim 13, further comprising an upper case coupled to an upper portion of the first accommodator and comprising a light output hole ,
wherein the light outputter 750 is disposed in the light output hole and outputs the light to an outside.

17. The refrigerator of claim 1, further comprising:
a second cap door to be disposed in a lower portion of the door;
a second accommodator to be disposed in the second cap door; and
a sound outputter to be disposed on the second accommodator.

18. The refrigerator of claim 17, wherein the sound outputter is disposed on a same plane as a lower surface of the second cap door.
